(19) United States
(12) Patent Application Publication
(10) Pub. No.: US 2025/0284457 A1
(43) Pub. Date: Sep. 11, 2025

(54) MULTIPLIER SUPPORTING VARIOUS PRECISIONS AND DATATYPES AND OPERATING METHOD THEREOF

(71) Applicants: Daegu Gyeongbuk Institute of Science and Technology, Daegu (KR); Korea University Research and Business Foundation, Seoul (KR)

(72) Inventors: Seock Hwan NOH, Incheon (KR); Jae Ha KUNG, Seoul (KR)

(73) Assignees: Daegu Gyeongbuk Institute of Science and Technology, Daegu (KR); Korea University Research and Business Foundation, Seoul (KR)

(21) Appl. No.: 18/758,498

(22) Filed: Jun. 28, 2024

(30) Foreign Application Priority Data
Mar. 5, 2024 (KR) 10-2024-0031558

(51) Int. Cl. G06F 7/523

(52) U.S. Cl. CPC G06F 7/523

(57) ABSTRACT

An electronic device includes a multiplier including a multiplication logic, a memory including at least one instruction, and at least one processor configured to execute the at least one instruction and to obtain a first input value and a second input value, identify datatypes and precisions of the first input value and the second input value, based on the identified datatypes and precisions, distribute bits of the first input value and bits of the second input value to sub-multiplication logics of the multiplication logic, and obtain at least one output of the multiplication logic based on outputs of the sub-multiplication logics.

### CROSS-REFERENCE TO RELATED APPLICATION

This application is based on and claims priority under 35 U.S.C. § 119 to Korean Patent Application No. 10-2024-0031558, filed on Mar. 5, 2024, in the Korean Intellectual Property Office, the disclosure of which is incorporated by reference herein in its entirety.

### BACKGROUND

### 1. Field

The disclosure relates to a multiply-accumulate (MAC) array and a hardware accelerator including the same, and more particularly, to a method of mapping data to a MAC operator that performs operations of a deep neural network model, an arrangement structure of MAC operators being included in a MAC array, and a method of transferring and receiving data between the MAC operators.

The disclosure relates to a multiplier that supports various precisions and datatypes and an operation method thereof, and more particularly, to a multiplier capable of identifying precisions and datatypes of values input in bit units and adaptively performing a multiplication operation and an operation method of the multiplier.

This research has been conducted with support from the Samsung Future Technology Promotion Project (Project Number: SRFC-IT1902-03).

### 2. Description of the Related Art

High-performance computing systems and continuously growing open-source datasets have led to extremely quick advances of artificial intelligence technology. In addition, along with the improved accuracy in artificial intelligence technology, artificial intelligence technology is used in many applications, such as computer vision, language modeling, and autonomous driving.

To use artificial intelligence for applications, training processes are required. In artificial intelligence technology, training refers to a process of updating weights of artificial intelligence models (for example, deep neural networks (DNNs)) by using specific datasets. As the weights are better updated, artificial intelligence models may perform given tasks better.

However, because training processes require extremely large amounts of calculation, training via central processing units (CPUs) takes extremely much time. Although graphics processing units (GPUs) facilitate parallel processing and thus less training time is required than in the case of CPUs, GPUs exhibit low usage due to the structural nature thereof. Recently, to overcome the drawbacks of CPUs and GPUs, a lot of dedicated hardware accelerators for performing calculations in DNNs have been proposed.

In addition, as the types of DNN models become more diverse and multiple users request operations of DNN models in a multitenant environment, the demand for parallel processing functions of dedicated hardware accelerators is increasing.

Also, as datatypes and precisions of values required for operations of DNN models become more diverse, MAC operators support various datatypes and precisions, and thus, the demand for area-efficient hardware accelerators is increasing.

### SUMMARY

Additional aspects will be set forth in part in the description which follows and, in part, will be apparent from the description, or may be learned by practice of the presented embodiments of the disclosure.

According to an aspect of the disclosure, an electronic device includes a multiplier including a multiplication logic, a memory storing at least one instruction, and at least one processor configured to execute the at least one instruction and to obtain a first input value and a second input value, identify datatypes and precisions of the first input value and the second input value, based on the identified datatypes and precisions, distribute bits of the first input value and bits of the second input value to sub-multiplication logics of the multiplication logic, and obtain at least one output of the multiplication logic based on outputs of the sub-multiplication logics.

According to another aspect of the disclosure, an operating method of a multiplier includes obtaining a first input value and a second input value, identifying datatypes and precisions of the first input value and the second input value, based on the identified datatypes and precisions, distributing bits of the first input value and bits of the second input value to sub-multiplication logics of a multiplication logic included in the multiplier, and obtaining at least one output of the multiplication logic based on outputs of the sub-multiplication logics.

According to another aspect of the disclosure, a multiplier includes a multiplication logic configured to, based on datatypes of a first input value and a second input value being integer types, perform a multiplication between the first input value and the second input value, and based on the datatypes being floating-point types, perform a multiplication between a mantissa of the first input value and a mantissa of the second input value, an addition logic configured to, based on the datatypes being floating-point types, sum an exponent of the first input value and an exponent of the second input value, and subtract bias values mapped to bit widths of the exponent of the first input value and the exponent of the second input value from a summation result, an XOR logic configured to, based on the datatypes being floating-point types, perform an XOR operation between a sign of the first input value and a sign of the second input value, a normalizer configured to, based on the datatypes being floating-point types, perform normalization an output of the multiplication logic and an output of the addition logic, a rounder configured to, based on the datatypes being floating-point types, perform rounding with a predefined bit width by using an output of the normalizer and an output of the XOR logic, and a multiplexer configured to, based on the datatypes being integer types, output the output of the multiplication logic, and based on the datatypes being floating-point types, output an output of the rounder.

According to another aspect of the disclosure, provided is a computer-readable recording medium having recorded thereon a program for performing an operating method of a multiplier in a computer.

### BRIEF DESCRIPTION OF THE DRAWINGS

The above and other aspects, features, and advantages of certain embodiments of the disclosure will be more apparent from the following description taken in conjunction with the accompanying drawings, in which:

The disclosure may be easily understood by combinations of the following detailed description and the accompanying drawings, and the reference numerals respectively refer to structural elements.

FIG. 1 is a block diagram for explaining a configuration of a hardware accelerator according to an embodiment of the disclosure;

FIG. 2 is a block diagram for explaining a configuration of a multiply-accumulate (MAC) array according to an embodiment of the disclosure;

FIG. 3 is a block diagram for explaining a configuration of a first array according to an embodiment of the disclosure;

FIG. 4 is a block diagram for explaining an operation of a MAC array according to an embodiment of the disclosure;

FIG. 5 is a conceptual diagram for explaining convolution operations according to an embodiment of the disclosure;

FIG. 6 is a conceptual diagram illustrating an operation of a MAC array that performs an accumulated convolution operation according to an embodiment of the disclosure;

FIG. 7 is a conceptual diagram illustrating an operation of a first sub-array that performs a non-accumulated convolution operation according to an embodiment of the disclosure;

FIG. 8 is a conceptual diagram for explaining a configuration and operation of a second sub-array according to an embodiment of the disclosure;

FIG. 9 is a block diagram for explaining a configuration of a MAC operator according to an embodiment of the disclosure;

FIG. 10 is a block diagram for explaining the configuration of a multiplier according to an embodiment of the disclosure;

FIGS. 11A to 11C are conceptual diagrams for explaining operations of a multiplier according to an embodiment of the disclosure;

FIG. 12 is a block diagram for explaining a configuration of multiplication logic according to an embodiment of the disclosure;

FIG. 13 is a conceptual diagram illustrating a multiplication operation according to an embodiment of the disclosure;

FIGS. 14A and 14B are block diagrams for explaining operations of a multiplication operation according to an embodiment of the disclosure;

FIG. 15 is a block diagram for explaining a configuration of addition logic according to an embodiment of the disclosure;

FIG. 16 is a block diagram for explaining a configuration of sub-addition logic according to an embodiment of the disclosure;

FIG. 17 is a block diagram for explaining a configuration of XOR logic according to an embodiment of the disclosure;

FIG. 18 is a block diagram for explaining a configuration of an electronic device according to an embodiment of the disclosure;

FIG. 19 is a flowchart for explaining an operation of a multiplier according to an embodiment of the disclosure;

FIG. 20 is a flowchart for explaining an operation of shifting logic according to an embodiment of the disclosure;

FIG. 21 is a flowchart for explaining an operation of a selective adder according to an embodiment of the disclosure.

FIG. 22 is a flowchart for explaining an operation of addition logic according to an embodiment of the disclosure;

FIG. 23 is a flowchart for explaining an operation of XOR logic according to an embodiment of the disclosure; and

FIG. 24 is a flowchart for explaining operations of a normalizer and a rounder according to an embodiment of the disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Although terms used herein are of among general terms which are currently and broadly used by considering functions in the disclosure, these terms may vary according to intentions of those of ordinary skill in the art, precedents, the emergence of new technologies, etc. In addition, there may be terms selected arbitrarily by the applicants in particular cases, and in these cases, the meaning of those terms will be described in detail in the corresponding portions of the detailed description. Therefore, the terms used herein should be defined based on the meaning thereof and descriptions made throughout the specification, rather than based on names simply called.

The singular terms used herein are intended to include the plural forms as well, unless the context clearly indicates otherwise. All terms used herein, including technical and scientific terms, have the same meaning as generally understood by those of ordinary skill in the art.

It will be understood that, throughout the specification, when a portion is referred to as “comprising” or “including” a structural element, the portion may further include another structural element in addition to the structural element rather than exclude the other structural element, unless otherwise stated. In addition, the term such as “ . . . unit”, “ . . . portion”, “ . . . module”, or the like used herein refers to a unit for processing at least one function or operation, and this may be implemented by hardware, software, or a combination of hardware and software

The expression “configured (or set) to” used herein may be used interchangeably with, for example, “suitable for”, “having the capacity to”, “designed to”, “adapted to”, “made to”, or “capable of” depending on the circumstances. The expression “configured (or set) to” does not essentially mean “specially designed in hardware to”. Rather, in some circumstances, the expression “system configured to” may mean that the system may perform an operation together with another device or parts. For example, the phrase “processor configured (or set) to perform A, B, and C” may mean a dedicated processor (for example, an embedded processor) for performing the operations, or a generic-purpose processor (for example, a CPU or an application processor) that may perform the operations by executing one or more software programs stored in a memory.

In addition, throughout the specification, it should be understood that, when a structural element is referred to as being “coupled to” or “connected to” another structural element, the structural element may be directly coupled to or directly connected to the other structural element or may be coupled to or connected to the other structural element with an intervening structural element therebetween, unless otherwise stated.

In the disclosure, functions related to “artificial intelligence” are operated by a processor and a memory. The processor may include one or more processors. Here, the one or more processors may include a general-purpose processor, such as a CPU, an application processor (AP), or a digital signal processor (DSP), a dedicated graphics processor, such as a graphics processing unit (GPU) or a vision processing unit (VPU), or a dedicated artificial intelligence processor, such as a neural processing unit (NPU). The one or more processors control input data to be processed according to an artificial intelligence model or predefined operation rules stored in a memory. Alternatively, when the one or more processors include dedicated artificial intelligence processors, the dedicated artificial intelligence processors may be designed with a hardware structure specialized in processing a specific artificial intelligence model.

The artificial intelligence model or the predefined operation rules are characterized by being made by training. Here, “being made by training” means that a basic artificial intelligence model is trained by a learning algorithm by using a large number of pieces of training data, and thus, the artificial intelligence model or the predefined operation rules set to perform intended features (or purposes) are made. Such training may be performed by a device itself in which artificial intelligence according to the disclosure is performed, or may be performed by a separate server and/or system. The learning algorithm may include, but is not limited to, for example, supervised learning, unsupervised learning, semi-supervised learning, or reinforcement learning.

In an embodiment of the disclosure, an “artificial intelligence model” may include a neural network model. The neural network model may include a plurality of neural network layers. Each of the plurality of neural network layers has a plurality of weight values and performs a neural network operation through an operation between an operation result of a previous layer and the plurality of weight values. The plurality of weight values of each of the plurality of neural network layers may be optimized by a training result of the artificial intelligence model. For example, the plurality of weight values may be updated such that a loss value or a cost value obtained by the artificial intelligence model during a training process is minimized. An artificial neural network model may include a deep neural network (DNN), for example, a convolutional neural network (CNN), a recurrent neural network (RNN), a restricted Boltzmann machine (RBM), a deep belied network (DBN), a bidirectional recurrent deep neural network (BRDNN), or a deep Q-network, but the disclosure is not limited thereto.

In the disclosure, a tensor may denote an n-dimensional array of data. Each dimension of the tensor may form an axis. For example, a 0-dimensional tensor may represent a scalar value, a 1-dimensional tensor may represent a vector value, and a 2-dimensional tensor may represent a matrix. For example, a 3 or more-dimensional tensor may include a plurality of matrices and may form 3 or more axes.

In the disclosure, a batch may indicate a unit for updating parameters by grouping all datasets for the training of the artificial intelligence model. For example, all the datasets may be grouped into a plurality of batches. The parameters of the artificial intelligence model may be updated for every one batch. One batch may include a predefined number of mini-batches

In the disclosure, multiply-accumulate (MAC) operators may be arranged in an n×m array in the form of n rows and m columns. The n×m array may perform n×m matrix operations by using the MAC operators.

In the disclosure, the expression “the processor may perform an A operation” may indicate that the processor may execute at least one instruction corresponding to the A operation.

Hereinafter, embodiments of the disclosure will be described in detail with reference to the accompanying drawings such that those of ordinary skill in the art may easily implement the embodiments. However, the disclosure may be implemented in different ways and is not limited to the embodiments described herein.

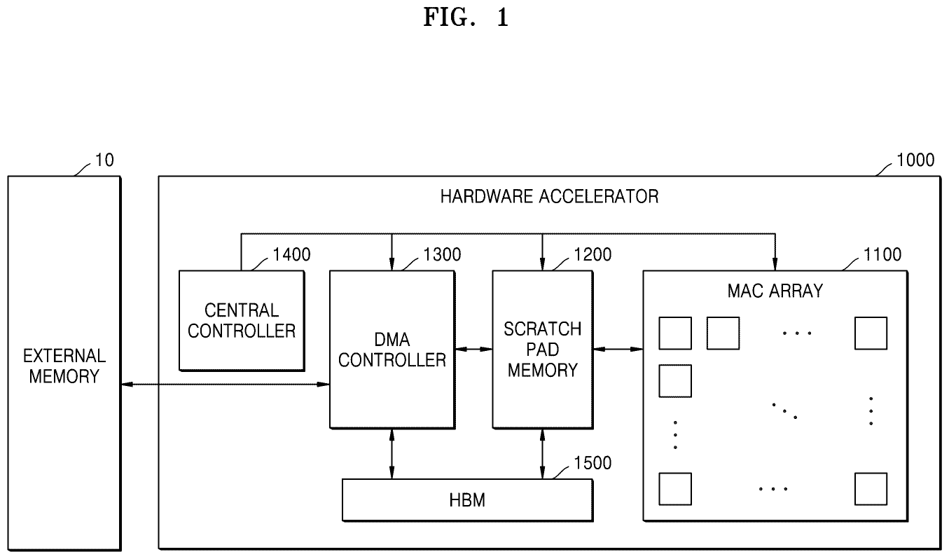

FIG. 1 is a block diagram for explaining a configuration of a hardware accelerator 100 according to an embodiment of the disclosure.

Referring to FIG. 1, the hardware accelerator 1000 may include a multiply-accumulate (MAC) array 1100, a scratchpad memory 1200, a direct memory access (DMA) controller 1300, a central controller 1400, and high bandwidth memory (HBM) 1500. However, all of the illustrated structural elements are not essential structural elements. The hardware accelerator 1000 may be implemented with more structural elements than the illustrated structural elements or may be implemented with fewer structural elements.

The MAC array 1100 may include a plurality of MAC operators. In the disclosure, a MAC operator may also be referred to as a MAC unit. The MAC operator may perform multiplications between input values. The MAC operator (e.g., a first MAC operator) may receive an output (or may also be referred to as a partial sum output) of an adjacent MAC operator (e.g., a second MAC operator). The MAC operator (e.g., the first MAC operator) may sum the output of the adjacent MAC operator (e.g., the second MAC operator) and a multiplication result. The MAC operator (e.g., the first MAC operator) may transfer a summation result to another adjacent MAC operator (e.g., a third MAC operator).

The MAC array 1100 may perform operations of at least one deep neural network (DNN) model. The operations of the DNN model may be required for learning or inference of the DNN model. For example, the operations of the DNN model may be divided into DNN operations and non-DNN operations. DNN operations may include non-cumulative operations such as weight gradient operation, depthwise (DW) convolution, dilated convolution, and up convolution, and cumulative operations such as (general) convolution, pointwise convolution, or fully connected layer operation. Non-DNN operations may include operations in non-DNN layers, such as ReLU, batch normalization, and softmax functions in the DNN model.

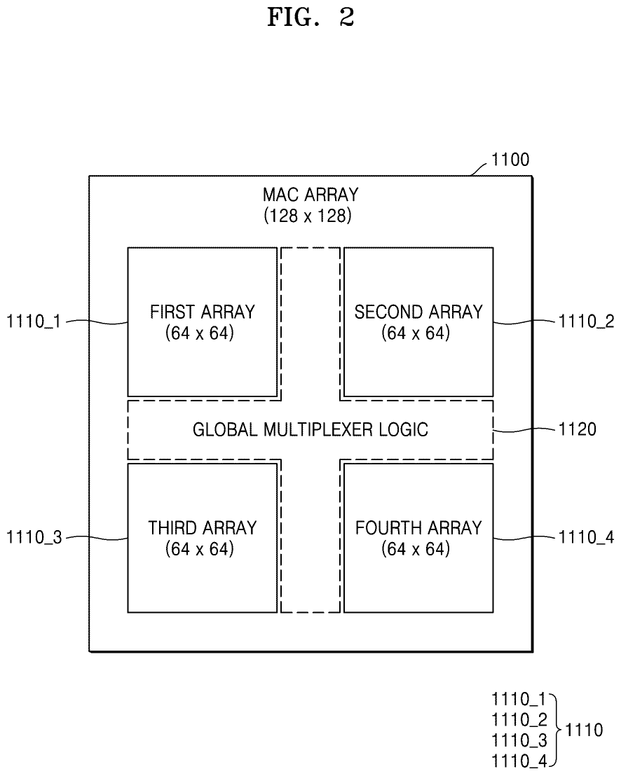

In an embodiment of the disclosure, the MAC array 1100 may perform DNN operations by using a plurality of MAC operators. The MAC array 1100 may group the plurality of MAC operators into at least one group. The at least one group may perform different DNN operations. In an embodiment of the disclosure, the MAC operators may be arranged in the MAC array 1100 in the form of 128×128. The specific configuration and operation of the MAC array 1100 will be described in detail with reference to FIG. 2.

In an embodiment of the disclosure, unlike shown in FIG. 1, the hardware accelerator 1000 may include a vector unit. The vector unit may include a plurality of arithmetic and logic units (ALUs). The vector unit may perform non-DNN operations by using the plurality of ALUs.

According to an embodiment of the disclosure, the MAC array 1100 may perform an operation on a plurality of DNN models or perform an operation on one DNN model in a multitenant environment, by combining the plurality of MAC operators into the at least one group or dividing the at least one group. According to an embodiment of the disclosure, the MAC array 1100 may support the multitenant environment through a flexible structure, thereby increasing hardware resource utilization with respect to the plurality of MAC operators.

The scratchpad memory 1200 may store data corresponding to operands required for the operation of the DNN model. For example, the scratchpad memory 1200 may store input tensors and/or weight tensors. The scratchpad memory 1200 may perform a function of prefetching data from the external memory 10 through the DMA controller 1300.

MAC array 1100 and/or vector unit may fetch data from scratchpad memory 1200. The scratchpad memory 1200 may perform a function of prefetching data from an external memory 10 through the DMA controller 1300.

The MAC array 1100 and/or the vector unit may store data in the scratchpad memory 1200. The scratchpad memory 1200 may store partial sum outputs calculated from the MAC array 1100 and/or the vector unit.

According to an embodiment of the disclosure, a compiler of the scratchpad memory 1200 may easily predict a memory access pattern by a deterministic data flow of the DNN operation. However, the disclosure is not limited thereto. In an embodiment of the disclosure, the scratchpad memory 1200 may be omitted, and the hardware accelerator 1000 may include a static random access memory (SRAM) cache.

The DMA controller 1300 may control data transfer between internal memories (e.g., the scratchpad memory 1200 and/or the HBM 1500), data transfer between an internal memory and the external memory 10, and/or data transfer between an internal memory and the MAC array 1100. The hardware accelerator 1000 may load data and/or programs from the external memory 10 by using the DMA controller 1300. The hardware accelerator 1000 may transfer data to the external memory 10 by using the DMA controller 1300.

The central controller 1400 may control the overall operations of the hardware accelerator 1000. The central controller 1400 may transfer control signals to the MAC array 1100, the scratchpad memory 1200, and the DMA controller 1300. The central controller 1400 may store program codes or instructions for controlling the hardware accelerator 1000. The central controller 1400 may support instructions such as interrupt, halt, synchronization, no-operation (NOP), etc. In an embodiment of the disclosure, the central controller 1400 may be implemented as a RISC-V CPU.

The central controller 1400 may transfer, to the MAC array 1100, a control signal to combine the MAC operators of the MAC array 1100 into the at least one group or to divide the at least one group. The central controller 1400 may transfer, to the MAC array 1100, a control signal to activate and/or deactivate at least one operation logic included in a multiplier of the MAC operator.

The HBM 1500 may store data required for the operation of the DNN model. The capacity of the HBM 1500 may be greater than the capacity of the scratchpad memory 1200. The HBM 1500 may receive data from the scratchpad memory 1200 or transfer data to the scratchpad memory 1200 through control of the DMA controller 1300.

FIG. 1 shows that the hardware accelerator 1000 includes the scratchpad memory 1200 and the HBM 1500 as internal memories, but the disclosure is not limited thereto. For example, the hardware accelerator 1000 may include at least one of a flash memory type memory, a hard disk type memory, a multimedia card micro type memory, a card type memory (for example, an SD or XD memory or the like), random access memory (RAM), static random access memory (SRAM), read-only memory (ROM), electrically erasable programmable read-only memory (EEPROM), programmable read-only memory (PROM), magnetic memory, a magnetic disk, and an optical disk.

FIG. 2 is a block diagram for explaining the configuration of the MAC array 1100 according to an embodiment of the disclosure. Redundant descriptions given with reference to FIG. 1 are omitted. For convenience of description, it is described that the MAC array 1100 is a MAC array in which 128×128 MAC operators are arranged, but the disclosure is not limited thereto. For example, the MAC array 1100 may be a MAC operator in which m×n MAC operators are arranged. Here, m and n may be natural numbers.

Referring to FIG. 1 along with FIG. 2, the MAC array 1100 may include a plurality of arrays 1110 and global multiplexer logic 1120. Each of the plurality of arrays 1100 may include the same number of MAC operators. For convenience of description, it is described that each of the plurality of arrays 1100 is an array in which 64×64 MAC operators are arranged, but the disclosure is not limited thereto.

The MAC array 1100 may include four 64×64 arrays 1110_1, 1110_2, 1110_3, and 1110_4. However, the disclosure is not limited thereto, and the MAC array 1100 may be configured to include smaller and more arrays, or include larger and fewer arrays.

The global multiplexer logic 1120 may connect or disconnect at least two of the plurality of arrays 1110. The global multiplexer logic 1120 may receive a first control signal from the central controller 1400. The first control signal may respond to whether the plurality of arrays 1110 are connected to each other.

In an embodiment of the disclosure, the first control signal may correspond to an operation mode of the MAC array 1100. For example, in a first operation mode, the global multiplexer logic 1120 may disconnect the plurality of arrays 1110 from each other. For example, in a second operation mode, the global multiplexer logic 1120 may connect at least two of the plurality of arrays 1110.

The connected arrays 1110 may transfer and receive data therebetween. For example, when the first array 1110_1 and the second array 1110_2 are connected to each other, the first array 1110_1 and the second array 1110_2 may perform a 128×64 matrix operation. For example, when the first array 1110_1 and the third array 1110_3 are connected to each other, the first array 1110_1 and the third array 1110_3 may perform a 64×128 matrix operation. For example, when the first array 1110_1, the second array 1110_2, the third array 1110_3, and the fourth array 1110_4 are all connected to each other, the first array 1110_1, the second array 1110_2, the third array 1110_3, and the fourth array 1110_4 may perform a 128×128 matrix operation.

For example, among the plurality of arrays 1110, two arrays (e.g., the second array 1110_2 and the fourth array 1110_4) may be grouped, and the remaining arrays may not be grouped. The two grouped arrays may perform a 128×64 matrix operation or a 64×128 matrix operation. The two grouped arrays may process an operation of a DNN model with a preset high priority, and the two ungrouped arrays may process an operation of a DNN model with a preset low priority.

The global multiplexer logic 1120 may include a plurality of multiplexers. Each of the plurality of multiplexers may or may not transfer an output of one array (e.g., the first array 1110_1) among the plurality of arrays 1110 to an adjacent array (e.g., the third array 1120_3) in response to a first control signal. For example, each of the plurality of multiplexers may transfer an output of one array (e.g., the first array 1110_1) among the plurality of arrays 1110 to an adjacent array (e.g., the third array 1120_3) based on the first control signal corresponding to a first logic value. For example, each of the plurality of multiplexers may not transfer an output of one array (e.g., the first array 1110_1) among the plurality of arrays 1110 to an adjacent array (e.g., the third array 1120_3) based on the first control signal corresponding to the first logic value.

In an embodiment of the disclosure, the plurality of arrays 1110 may be grouped into at least one array group by the global multiplexer logic 1120. The MAC array 1100 may perform operations on a plurality of tenants. Each of the at least one array group may perform operations on different single tenants among the plurality of tenants.

The plurality of multiplexers may be connected between a plurality of MAC operators disposed in a last row, a last column, a first row, or a first column of the arrays.

In an embodiment of the disclosure, the MAC operators arranged in a last row of the first array 1110_1 may be respectively connected to the plurality of multiplexers. The corresponding multiplexers may be respectively connected to the MAC operators arranged in a first row of the third array 1110_3.

In an embodiment of the disclosure, the MAC operators arranged in a last column of the first array 1110_1 may be respectively connected to the plurality of multiplexers. The corresponding multiplexers may be respectively connected to the MAC operators arranged in a first column of the second array 1110_2.

In an embodiment of the disclosure, the MAC operators arranged in a last column of the third array 1110_3 may be respectively connected to the plurality of multiplexers. The corresponding multiplexers may be respectively connected to the MAC operators arranged in a first column of the fourth array 1110_4.

In an embodiment of the disclosure, the MAC operators arranged in a last row of the second array 1110_2 may be respectively connected to plurality of multiplexers. The corresponding multiplexers may be respectively connected to the MAC operators arranged in a first row of the fourth array 1110_4.

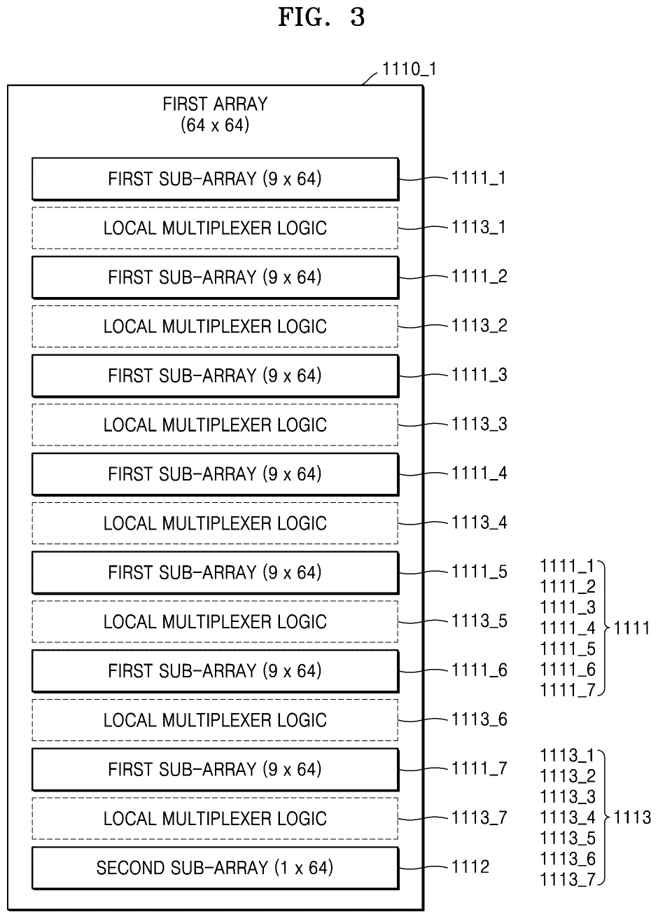

FIG. 3 is a block diagram for explaining the configuration of the first array 1110_1 according to an embodiment of the disclosure. Redundant descriptions given with reference to FIGS. 1 and 2 are omitted.

Referring to FIGS. 1 and 2 along with FIG. 3, the first array 1110_1 may include a plurality of sub-arrays including a plurality of first sub-arrays 1111 and a second sub-array 1112. The first array 1110_1 may include local multiplexer logic 1113.

In an embodiment of the disclosure, MAC operators may be arranged in each of the plurality of first sub-arrays 1111 in the form of 9×64. In an embodiment of the disclosure, the number of first sub-arrays 1111 may be 7. For example, the first array 1110_1 may include seven first sub-arrays 1111_1 to 1111_7.

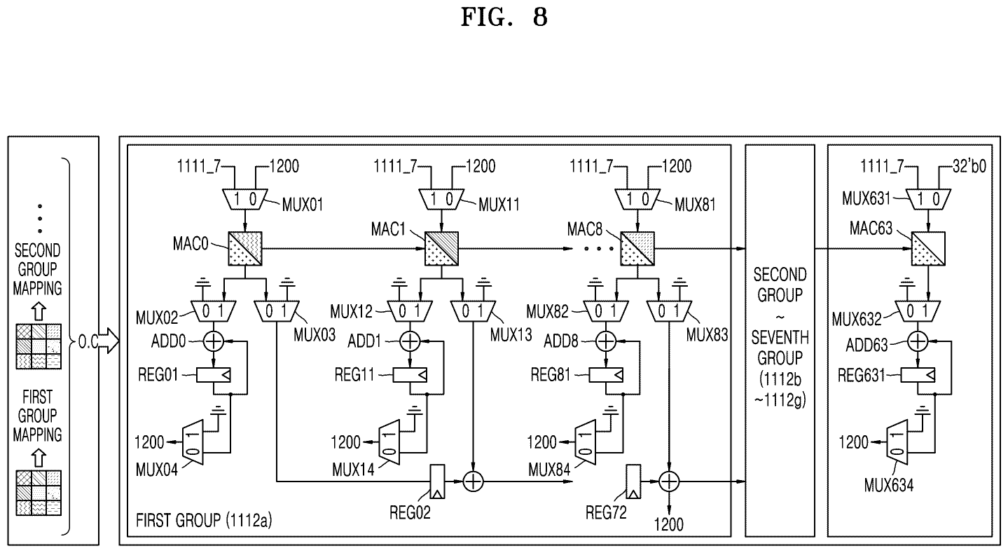

In an embodiment of the disclosure, MAC operators may be arranged in the second sub-array 1112 in the form of 1×64. The specific structure of the second sub-array 1112 will be described in detail in FIG. 8.

The local multiplexer logic 1113 may be disposed between the plurality of sub-arrays. For example, local multiplexer logics 1113_1 to 1113_7 may be disposed between the first sub-arrays 1111_1 to 1111_7 and the second sub-array 1112. The local multiplexer logic 1113 may connect or disconnect the plurality of sub-arrays. For example, the local multiplexer logic 1113_1 may be disposed between the first sub-array 1111_1 and the first sub-array 1111_2. The local multiplexer logic 1113_1 may connect or disconnect the first sub-array 1111_1 and the first sub-array 1111_2. Exemplarily, the local multiplexer logic 1113_7 may be disposed between the first sub-array 1111_7 and the second sub-array 1112. The local multiplexer logic 1113_7 may connect or disconnect the first sub-array 1111_7 and the second sub-array 1112 to or from each other.

In an embodiment of the disclosure, the local multiplexer logic 1113 may connect or disconnect the plurality of sub-arrays to or from each other based on a second control signal. The local multiplexer logic 1113 may receive the second control signal from the central controller 1400. The second control signal may correspond to whether the plurality of sub-arrays are connected to each other.

In an embodiment of the disclosure, the second control signal may correspond to an operation mode of the first array 1110_1. For example, in a first operation mode, the local multiplexer logic 1113 may disconnect the plurality of sub-arrays from each other. For example, in a second operation mode, the local multiplexer logic 1113 may connect the plurality of sub-arrays to each other.

In an embodiment of the disclosure, the plurality of sub-arrays may perform a convolution operation between a first tensor and a second tensor. The plurality of sub-arrays may generate a partial sum tensor as a result of a convolution operation. For example, based on the second control signal indicating the first operation mode of the first array 1110_1, the first array 1110_1 may accumulate partial sum tensors output by the plurality of sub-arrays. For example, based on the second control signal indicating the second operation mode of the first array 1110_1, the first array 1110_1 may not accumulate partial sum tensors output by the plurality of sub-arrays.

In an embodiment of the disclosure, it will be described below under the assumption that the first array 1110_1 operates in the first operation. The first array 1110_1 may perform a 64×64 matrix operation. For example, an output of the first sub-array 1111_1 may be transferred to the first sub-array 1111_2 through the local multiplexer logic 1113_1. An output of the first sub-array 1111_2 may be transferred to the first sub-array 1111_3 through the local multiplexer logic 1113_2. An output of the first sub-array 1111_3 may be transferred to the first sub-array 1111_4 through the local multiplexer logic 1113_3. An output of the first sub-array 1111_4 may be transferred to the first sub-array 1111_5 through the local multiplexer logic 1113_4. An output of the first sub-array 1111_5 may be transferred to the first sub-array 1111_6 through the local multiplexer logic 1113_5. An output of the first sub-array 1111_6 may be transferred to the first sub-array 1111_7 through the local multiplexer logic 1113_6. An output of the first sub-array 1111_7 may be transferred to the second sub-array 1112 through the local multiplexer logic 1113_7.

In an embodiment of the disclosure, it will be described below under the assumption that the first array 1110_1 operates in the second operation mode. Each of the outputs of the first sub-arrays 1111_1 to 1111_7 and the second sub-array 1112 may be transferred to the scratchpad memory 1200.

For convenience of description, the first array 1110_1 has been described as an example, but the configurations, functions, and operations of the plurality of arrays 1100 (e.g., the second array 1110_2, the third array 1110_3, and the fourth array 1110_4 in FIG. 2) included in the MAC array (1100 in FIG. 2) may respectively correspond to the configuration, function, and operation of the first array 1110_1.

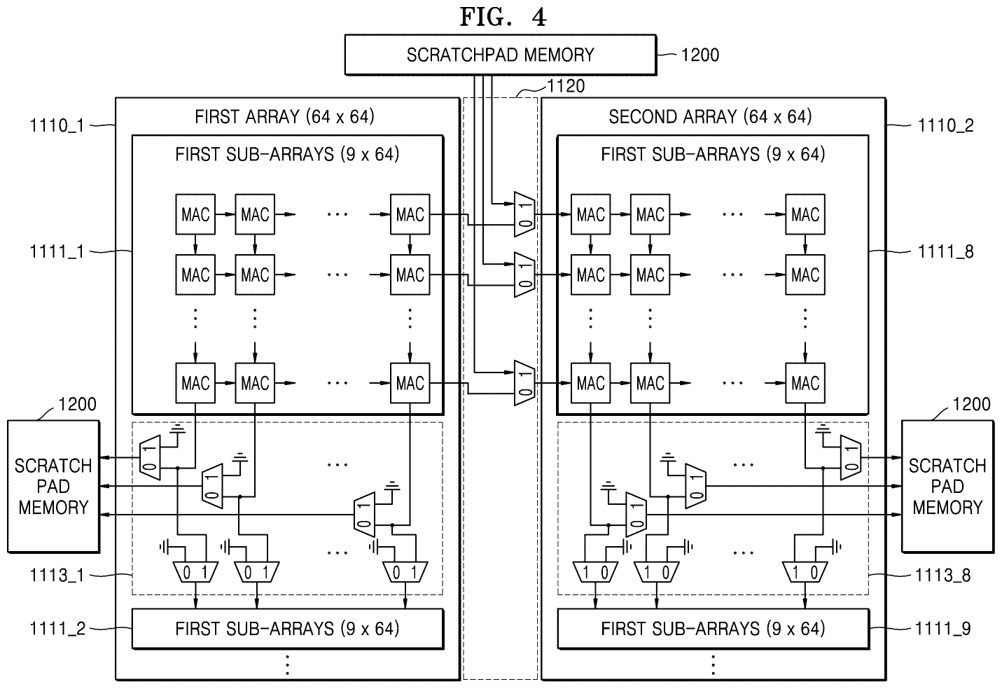

FIG. 4 is a block diagram for explaining the operation of the MAC array 1100 according to an embodiment of the disclosure. Redundant descriptions given with reference to FIGS. 1 to 3 are omitted. For convenience of description, at least some of components shown in FIGS. 1 to 3 are omitted in FIG. 4.

Referring to FIGS. 1 to 3 along with FIG. 4, the MAC array 1100 may include a plurality of MAC operators. The MAC operator may transfer a partial sum output to another MAC operator (e.g., a lower MAC operator) in a column direction. The MAC operator may forward data of an input tensor to another MAC operator (e.g., a right MAC operator) in a row direction.

The MAC array 1100 may include the first array 1110_1, the second array 1110_2, and the global multiplexer logic 1120. Multiplexers of the global multiplexer logic 1120 may be disposed between MAC operators in a last row of the first array 1110_1 and MAC operators in a first row of the second array 1110_2. For example, outputs (e.g., forwarded data) of the MAC operators in the last row of the first array 1110_1 may be respectively transferred to the multiplexers of the global multiplexer logic 1120.

Each of the MAC operators in the last row of the first array 1110_1 may correspond to one multiplexer. By an operation of one multiplexer that operates based on a logic value of a first control signal, the output of each of the MAC operators in the last row of the first array 1110_1 or data from the scratchpad memory 1200 may be transferred to each of the MAC operators in the first column of the second array 1110_2. For example, when the first control signal has the first logical value (e.g., ‘0’), the outputs (e.g., forwarded data) of the MAC operators in the last row of the first array 1110_1 may be respectively transferred to the MAC operators in the first column of the second array 1110_2. For example, when the first control signal has a second logic value (e.g., ‘1’), the data from the scratchpad memory 1200 may be transferred to each of the MAC operators in the first column of the second array 1110_2.

The first array 1110_1 may include the first sub-array 1111_1, the first sub-array 1111_2, and the local multiplexer logic 1113_1. MAC operators in a last row of the first sub-array 1111_1 may be respectively connected to multiplexers of the local multiplexer logic 1113_1. Outputs (e.g., partial sum outputs) of the MAC operators in the last row of the first sub-array 1111_1 may be respectively connected to multiplexers of the local multiplexer logic 1113_1.

Each of the MAC operators in a last row of the first sub-array 1111_1 may correspond to two multiplexers. By operations of the two multiplexers operating based on a logic value of the second control signal, the output of each of the MAC operators in the last row may be transferred to the scratchpad memory 1200 or to each of MAC operators in a first row of the first sub-array 1111_2. For example, when the second control signal has a first logic value (e.g., ‘0’), the output of the MAC operator may be transferred to the scratchpad memory 1200. For example, when the second control signal has a second logic value (e.g., ‘1’), the output of the MAC operator may be transferred to the first sub-array 1111_2.

The second array 1110_2 may include a first sub-array 1111_8 and a first sub-array 1111_9. The configurations, operations, and functions of the first sub-array 1111_8, the first sub-array 1111_9, and the local multiplexer logic 1113_8 may respectively correspond to the configurations, operations, and functions of the first sub-array 1111_1, the first sub-array 1111_2, and the local multiplexer logic 1113_8.

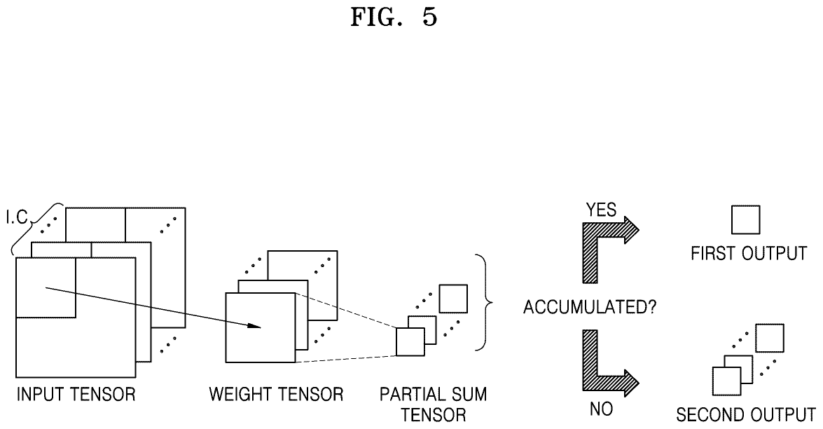

FIG. 5 is a conceptual diagram for explaining convolution operations according to an embodiment of the disclosure.

Referring to FIG. 1 along with FIG. 5, the MAC array 1100 may perform convolution operations between an input tensor and a weight tensor. According to types of convolution operations, the MAC array 1100 may obtain a first output that accumulates partial sum tensors that are results of a convolution operation between the input tensor and the weight tensor, or may obtain a second output that does not accumulate partial sum tensors.

The convolution operations may be divided into a first operation that accumulates partial sum tensors in a direction of an input channel I.C of the input tensor, and a second operation that does not accumulate partial sum tensors in the direction of the input channel I.C of the input tensor. Examples of operations are shown in Table 1 below.

TABLE 1

| Types of operations | Examples |
|---|---|
| Accumulation? Yes | Conventional convolution, |
| | Fully-connected layer, GEMM, GEMV |
| Accumulation? No | Depthwise convolution, Dilated convolution, |
| | Weight gradient (∂ [symbol] /∂W) in the training process |
| | of convolutions |

Referring to Table 1, for example, when a weight gradient operation, DW convolution, or dilated convolution, etc. in training of a DNN model is performed, the MAC array 1100 may perform a first operation. For example, when performing a (general) convolution in which operation results are accumulated, fully connected layer operation, general matrix-matrix multiplication (GEMM) operation, or general matrix vector multiplication (GEMV) operation, the MAC array 1100 may perform the first operation.

In an embodiment of the disclosure, the MAC array 1100 may identify which operation is required at each step of an operation of at least one DNN model being operated. The MAC array 1100 may selectively accumulate and output operation results according to results of identification.

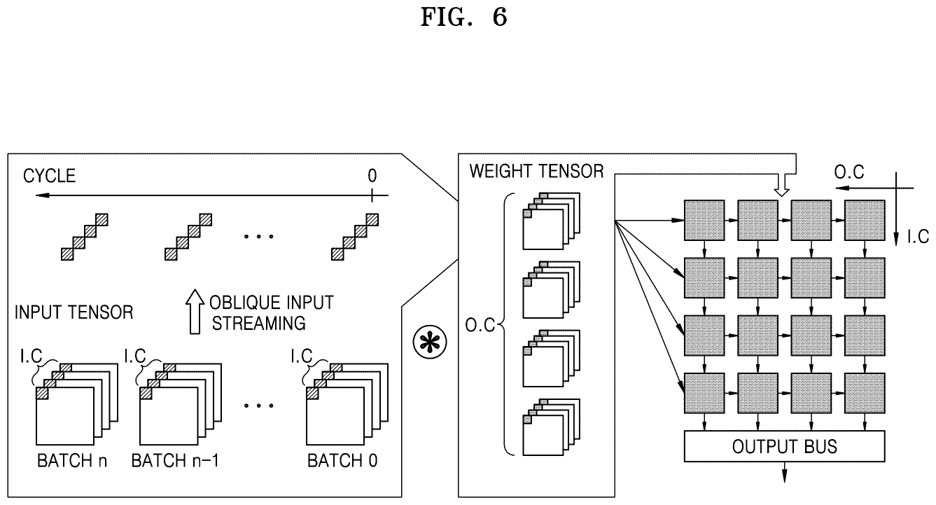

FIG. 6 is a conceptual diagram illustrating the operation of a MAC array that performs an accumulated convolution operation according to an embodiment of the disclosure. Redundant descriptions given with reference to FIGS. 1 to 5 are omitted.

Referring to FIG. 6, input training data may include a plurality of batches. Each of the plurality of batches may include an input tensor, which is a three-dimensional (3D) tensor with a depth of the input channel I.C. Data of input tensors corresponding to the plurality of batches may be prefetched to the MAC array in the form of “dataflow algorithm of oblique input streaming”.

When the accumulated convolution operation is performed in a direction of the input channel I.C of the input tensor, data in the direction of the input channel I.C of the input tensor may be mapped in a column direction of MAC operators of the MAC array.

Weight values that perform the convolution operation on input training data may include weight tensors, which are 3D tensors with a depth of the input channel I.C. The number of weight tensors may be equal to the number of output channels O.C. When the accumulated convolution operation is performed in the direction of the input channel I.C of the input tensor, data in a direction of the output channel O.C of the weight tensor may be mapped in a row direction of the MAC operators of the MAC array.

FIG. 6 shows a 4×4 array, but referring to FIG. 2 along with FIG. 6, data of the input channel I.C. may be input in the column direction of the plurality of arrays 1110 in the form of 64×64, and data of the output channel O.C may be input in the row direction.

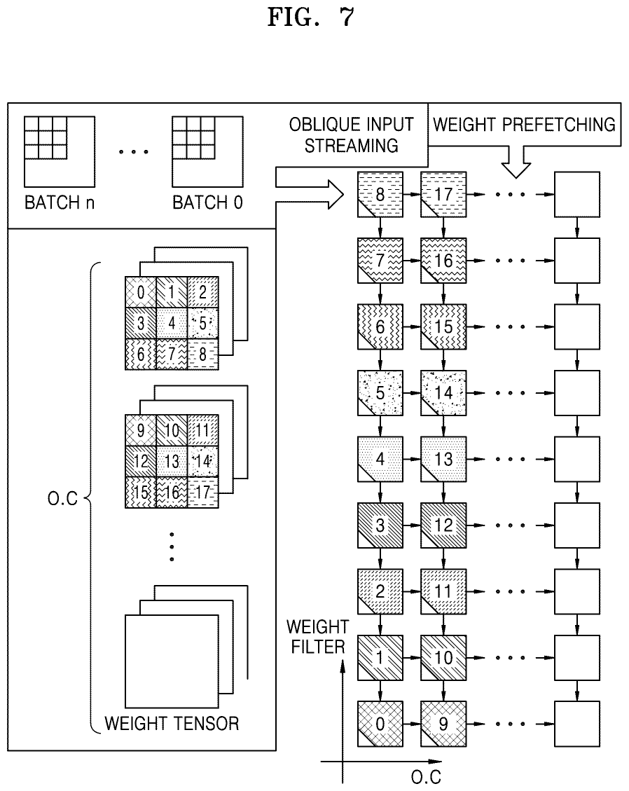

FIG. 7 is a conceptual diagram illustrating the operation of a first sub-array that performs a non-accumulated convolution operation according to an embodiment of the disclosure. Redundant descriptions given with reference to FIGS. 1 to 6 are omitted.

Referring to FIG. 7, MAC operators may be disposed in the sub-array (e.g., the first sub-array 1111_1 in FIG. 3) in the form of 9×64. When the non-accumulated convolution operation is performed in a direction of the input channel I.C of an input tensor, elements of a weight filter may be mapped in a column direction of the sub-array, and data in a direction of the output channel O.C may be mapped in a row direction. The elements of the weight filter may be prefetched in the column direction of the sub-array, and the data in the direction of the output channel O.C may be prefetched in the row direction. For example, the weight filter may correspond to one channel of a weight tensor, which is a 3D tensor.

Similar to that described with reference to FIG. 6, training data may include input tensors corresponding to a plurality of batches. The input tensors may be input to the sub-array in the form of “dataflow algorithm of oblique input streaming”.

Because partial sums are not accumulated in the direction of the input channel I.C, a final output from one column of the sub-array may not be transferred to a MAC operator of another sub-array, but transferred to a memory (e.g., the scratchpad memory (1200 in FIG. 1)).

FIG. 8 is a conceptual diagram for explaining the configuration and operation of the second sub-array 1112 according to an embodiment of the disclosure. Redundant descriptions given with reference to FIGS. 1 to 8 are omitted.

Referring to FIG. 3 along with FIG. 8, the second sub-array 1112 may include 64 MAC operators MAC0 to MAC63.

When an accumulated operation is performed in a direction of an input channel, the second sub-array 1112 may not be internally divided and may perform a 64×64 matrix operation together with the first sub-arrays 1111.

When a non-accumulated operation is performed in the direction of the input channel, the second sub-array 1112 may be divided into a plurality of groups. For example, the second sub-array 1112 may be divided into seven groups. The second sub-array 1112 may be divided into first to seventh groups 1112a to 1112g. Each of the first to seventh groups 1112a to 1112g may perform and output 9 MAC operations.

For convenience of description, circuit components arranged in the first group 1112a of the second sub-array 1112 will be mainly described below. The multiplexer MUX01 may output one of an output of the first sub-array 1111_7 or data loaded from the scratchpad memory 1200 based on a second control signal. For example, in response to the second control signal having a first logical value (e.g., ‘0’), the multiplexer MUX01 may output the data loaded from the scratchpad memory 1200. For example, in response to the second control signal having a second logic value (e.g., ‘1’), the multiplexer MUX01 may output an output of the first sub-array 1111_7.

For example, when the second control signal has the first logic value (e.g., ‘0’), the non-accumulated operation may be performed in the direction of the input channel, and when the second control signal has the second logic value (e.g., ‘1’)), the accumulated operation may be performed in the direction of the input channel.

The configuration, function, and operation of the multiplexer MUX01 may correspond to the configuration, function, and operation of each of the other multiplexers (e.g., MUX11, MUX81, MUX631, etc.) connected to the other MAC operators MAC1 to MAC63.

The MAC operator MAC0 may be connected to the multiplexer MUX01. The MAC operator MAC0 may perform a multiplication operation based on an output of the multiplexer MUX01 and data of an input tensor. The data of the input tensor may be forwarded to other adjacent MAC operators (e.g., MAC1). The configuration, function, and operation of the MAC operator MAC0 may correspond to the configuration, function, and operation of each of the other MAC operators (e.g., MAC1, MAC8, MAC63, etc.).

A multiplexer MUX02 may be connected to an adder ADD0. The multiplexer MUX02 may transfer a result of the multiplication operation of the MAC operator MAC0 to the adder ADD0 based on the second control signal. The configuration, function, and operation of the multiplexer MUX02 may correspond to the configuration, function, and operation of each of similarly arranged multiplexers (e.g., MUX12, MUX82, MUX632, etc.).

The adder ADD0 may be connected to a register REG0. The adder ADD0 may sum a value stored in the register REG0 and an output value of the multiplexer MUX02. The configuration, function, and operation of the adder ADD0 may correspond to the configuration, function, and operation of each of similarly arranged adders (e.g., ADD1, MUX8, MUX63, etc.).

The register REG0 may be connected to a multiplexer MUX04. The register REG0 may store an output value of the adder ADD0. The register REG0 may transfer the output value of the adder ADD0 to the multiplexer MUX04. The configuration, function, and operation of the register REG0 may correspond to the configuration, function, and operation of each of similarly arranged registers (e.g., REG1, REG8, REG63, etc.).

The multiplexer MUX04 may or may not transfer the stored value of the register REG0 to the scratchpad memory 1200 based on a fourth control signal. The configuration, function, and operation of the multiplexer MUX04 may correspond to the configuration, function, and operation of each of similarly arranged multiplexers (e.g., MUX14, MUX84, MUX634, etc.).

A multiplexer MUX03 may be connected to a register REG02. The multiplexer MUX03 may transfer the result of the multiplication operation of the MAC operator MAC0 to the register REG02 based on the second control signal. The configuration, function, and operation of the multiplexer MUX03 may correspond to the configuration, function, and operation of each of similarly arranged multiplexers (e.g., MUX13, MUX83, etc.).

The register REG02 may store an output value of the multiplexer MUX03. The output value stored in the register REG02 and an output value of a multiplexer MUX13 of the adjacent MAC operator MAC1 may be summed. A summation value may be summed back to an output value of a multiplexer MUX23 of the next adjacent MAC operator MAC2.

When a non-accumulated operation is performed in the direction of the input channel, by the functions and operations of the above-described circuit elements, outputs of the nine MAC operators may be summed, and a summation value may be transferred to the scratchpad memory 1200. For example, in the case of the first group 1112a, a value stored in a register REG72 and an output of a multiplexer MUX83 may be summed and transferred to the scratchpad memory 1200.

The configuration, operation, and function of each of the second to seventh groups 1112b to 1112g correspond to the configuration, operation, and function of the above-described first group 1112a, and thus, descriptions thereof are omitted.

When the MAC operator MAC63 that does not belong to the first to seventh groups 1112a to 1112g performs the non-accumulated operation in the direction of the input channel, data may not be mapped. However, when performing the accumulated operation in the direction of the input channel, the MAC operator MAC63 may transfer a result value to the scratchpad memory 1200 by using a multiplexer MUX632, an adder ADD63, a register REG631, and a multiplexer MUX634.

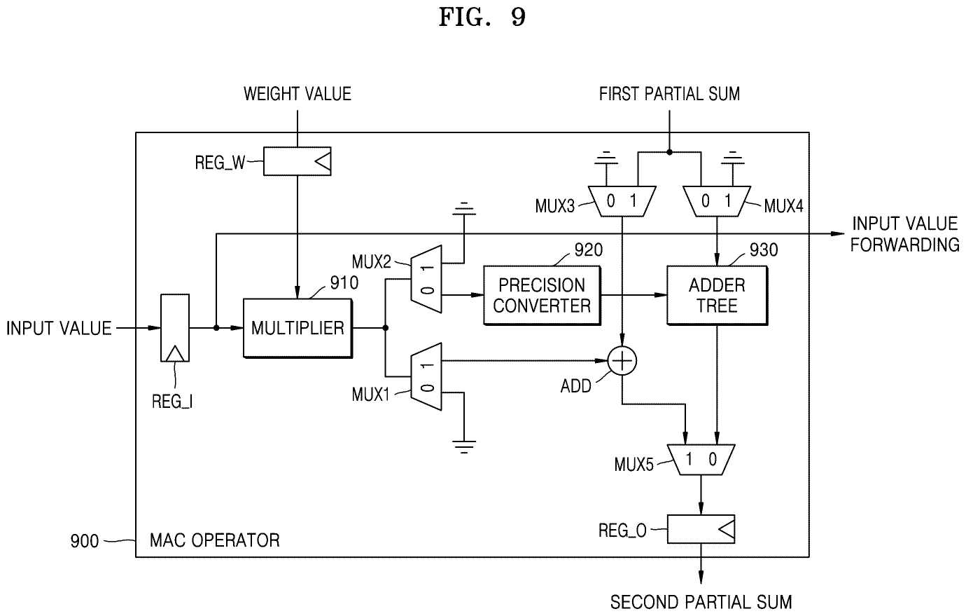

FIG. 9 is a block diagram for explaining the configuration of a MAC array 900 according to an embodiment of the disclosure. Redundant descriptions given with reference to FIGS. 1 to 8 are omitted. Referring to FIGS. 1 to 8 together, the configuration, operation, and function of each of MAC operators included in the MAC array 1100, the plurality of arrays 1110, the first sub-arrays 1111, and the second sub-array 1112 may respectively correspond to the configuration, operation, and function of the MAC operator 900 of FIG. 9.

The MAC operator 900 may include a multiplier 910, an adder ADD, a precision converter 920, an adder tree 930, multiplexers MUX1 to MUX5, and registers REG_I, REG_W, and REG_O.

The register REG_I may receive an input value. For example, the input value may include bits with a predefined bit width. The register REG_I may store the input value. The register REG_I may be connected to the multiplier 910. The register REG_I may transfer the stored input value to the multiplier 910. The register REG_I may be connected to a multiplier of an adjacent MAC operator to forward the stored input value to the adjacent MAC operator.

The register REG_W may receive a weight value. For example, the weight value may include bits with a predefined bit width. The register REG_W may store the weight value. The register REG_W may be connected to the multiplier 910. The register REG_W may transfer the stored weight value to the multiplier 910.

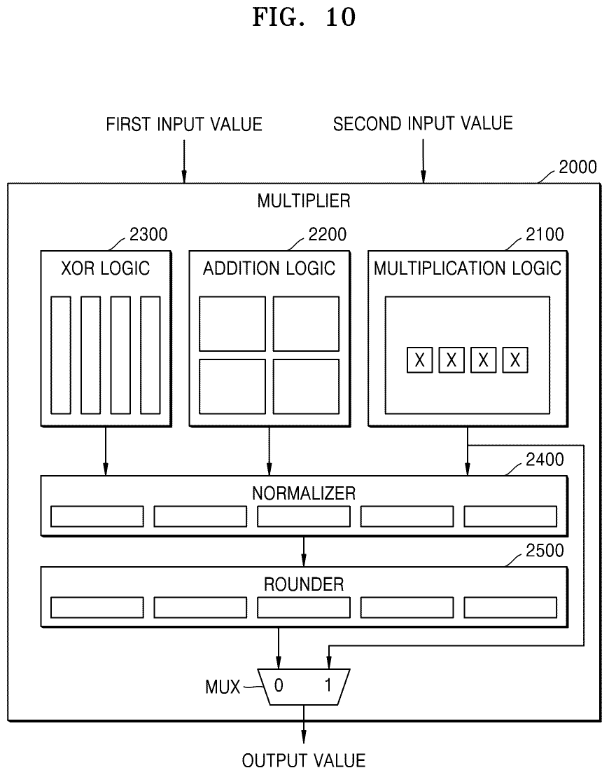

The multiplier 910 may load the input value from the register REG_I and the weight value from the register REG_W. The multiplier 910 may perform a multiplication operation between the input value and the weight value. The multiplier 910 may be connected to the multiplexer MUX1 and the multiplexer MUX2. The multiplier 910 may support various precisions and datatypes. According to an embodiment of the disclosure, the multiplier 910 may operate flexibly according to precisions and datatypes of the input value and the weight value. The specific structure and operation of the multiplier 910 will be described in detail with reference to FIG. 10.

The multiplexer MUX1 may or may not transfer an output of the multiplier 910 to the adder ADD based on a third control signal. Here, the third control signal may correspond to whether the datatypes of the input value and the weight value integer types or floating-point types. For example, when the third control signal has a first logical value (e.g., ‘0’), the datatypes of the input value and the weight value may be floating-point types, and when the third control signal has a second logical value (e.g., ‘1’), the datatypes of the input value and the weight value may be integer types.

For example, when the third control signal has the first logic value (e.g., ‘0’), the multiplexer MUX1 may not transfer the output of the multiplier 910 to the adder ADD. For example, when the third control signal has the second logic value (e.g., ‘1’), the multiplexer MUX1 may transfer the output of the multiplier 910 to the adder ADD.

The multiplexer MUX2 may or may not transfer the output of the multiplier 910 to the precision converter 920 based on the third control signal. For example, when the third control signal has the first logic value (e.g., ‘0’), the multiplexer MUX1 may transfer the output of the multiplier 910 to the precision converter 920. For example, when the third control signal has the second logic value (e.g., ‘1’), the multiplexer MUX1 may not transfer the output of the multiplier 910 to the precision converter 920.

The multiplexer MUX3 and the multiplexer MUX4 may receive a first partial sum, which is a partial sum output of the adjacent MAC operator. The multiplexer MUX3 and MUX4 may transfer the first partial sum to other structural elements based on the third control signal. For example, when the third control signal has the first logical value (e.g., ‘0’), the multiplexer MUX4 may transfer the first partial sum to the adder tree 930. For example, when the third control signal has the second logic value (e.g., ‘1’), the multiplexer MUX3 may transfer the first partial sum to the adder ADD.

The precision converter 920 may convert precision of the output of the multiplier 910. For example, when the input value and the weight value are of floating-point types, a result of multiplication performed by the multiplier 910 may be converted to floating-point type 32-bit data through the precision converter 920. According to an embodiment of the disclosure, accumulated errors of multiplication results may be prevented through the function of the precision converter 920. The precision converter 920 may convert the output of the multiplier 910 to have a predefined bit width. The precision converter 920 may transfer a converted value to the adder tree 930. The adder tree 930 may output a second partial sum by summing the first partial sum and an output of the precision converter 920.

The adder ADD may sum the output of the multiplier 910 and the first partial sum. The multiplexer MUX5 may transfer the second partial sum to another adjacent MAC operator by outputting an output of the adder ADD or an output of the adder tree 930. For example, when the third control signal has the first logical value (e.g., ‘0’), the multiplexer MUX5 may output the output of the adder tree 930. For example, when the third control signal has the second logic value (e.g., ‘1’), the multiplexer MUX5 may output the output of the adder ADD.

The register REG_O may store an output of the multiplexer MUX5. The register REG_O may transfer the stored output value, that is, the second partial sum, to another adjacent MAC operator. The other adjacent MAC operator may load the second partial sum from the register REG_O.

FIG. 10 is a block diagram for explaining a configuration of a multiplier 2000 according to an embodiment of the disclosure. Redundant descriptions given with reference to FIGS. 1 to 9 are omitted. The configuration, operation, and function of the multiplier 910 of FIG. 9 may respectively correspond to the configuration, operation, and function of the multiplier 2000 of FIG. 10. However, the disclosure is not limited thereto, and the multiplier 2000 may be disposed in a processor (e.g., a central processing unit (CPU), a graphics processing unit (GPU), a neural processing unit (NPU), etc.) by using various operators other than a MAC operator.

Referring to FIG. 10, the multiplier 2000 may include multiplication logic 2100, addition logic 2200, XOR logic 2300, a normalizer 2400, a rounder 2500, and a multiplexer MUX. However, all of the illustrated structural elements are not essential structural elements. The multiplier 2000 may be implemented with more structural elements than the illustrated structural elements shown, or may be implemented with fewer structural elements.

The multiplication logic 2100 may include a plurality of sub-multiplication logics. Four sub-multiplication logics are shown in FIG. 10, but the number of sub-multiplication logics is not limited thereto. The multiplication logic 2100 may output one result value or a plurality of result values based on a first input value and a second input value by using the sub-multiplication logics.

In an embodiment of the disclosure, the multiplication logic 2100 may be implemented as a carry-save multiplier (CSM), but the disclosure is not limited thereto.

In an embodiment of the disclosure, the multiplication logic 2100 may perform an 8b×8b multiplication operation, and each of the sub-multiplication logics may perform a 4b×4b multiplication operation, but the disclosure is not limited thereto. In this case, the multiplication logic 2100 may perform one 8b×8b multiplication operation, two 4b×8b operations, two 8b×4b operations, or four 4b×4b operations.

Different data may be mapped to the multiplication logic 2100 according to precisions and datatypes of the first input value and the second input value. For example, the multiplication logic 2100 may perform multiplication between the first input value and the second input value based on datatypes of the first input value and the second input value being integer types. For example, the multiplication logic 2100 may perform multiplication between a mantissa of the first input value and a mantissa of the second input value, based on datatypes of the first input value and the second input value being floating-point types.

The multiplication logic 2100 may be connected to the normalizer 2400 and the multiplexer MUX. The multiplication logic 2100 may transfer an operation result to the normalizer 2400 or to the multiplexer MUX.

The addition logic 2200 may include at least one sub-addition logic. Four sub-addition logics are shown in FIG. 10, but the number of at least one sub-addition logic is not limited thereto. The at least one sub-addition logic may respectively correspond to at least one output value of the multiplication logic 2100. In an embodiment of the disclosure, the number of at least one sub-addition logic may correspond to the maximum number of outputs of the multiplication logic 2100. The at least one sub-addition logic may be arranged in the same number as the maximum number of at least one output of the multiplication logic 2100. Each of the at least one sub-addition logic may be activated or deactivated according to the datatypes and precisions of the first input value and the second input value.

The addition logic 2200 may be deactivated based on the datatypes of the first input value and the second input value being integer types. The addition logic 2200 may sum an exponent of the first input value and an exponent of the second input value based on the datatypes of the first input value and the second input value being floating-point types. Each of the first input value and the second input value may include a plurality of floating-point values. In this case, the addition logic 2200 may perform summation between an exponent of one of the plurality of floating-point values of the first input value and an exponent of one of the plurality of floating-point values of the second input value.

The addition logic 2200 may subtract a bias value mapped to a bit width of the exponent of the first input value and the exponent of the second input value from a summation result. The bias value may correspond to bit widths of the precisions or exponents of the first and second input values. For example, the bias value may be 2^{(bit width of exponent)}−1.

The addition logic 2200 may be connected to the normalizer 2400. The addition logic 2200 may transfer the operation result to the normalizer 2400.

The XOR logic 2300 may perform an exclusive OR operation. The XOR logic 2300 may be deactivated based on the datatypes of the first input value and the second input value being integer types. The XOR logic 2300 may perform an XOR operation between a sign of the first input value and a sign of the second input value, based on the datatypes of the first input value and the second input value being floating-point types.

The XOR logic 2300 may include at least one sub-XOR logic. Four sub-XOR logics are shown in FIG. 10, but the number of at least one sub-XOR logic is not limited thereto. The at least one XOR addition logic may respectively correspond to the at least one output value of the multiplication logic 2100. In an embodiment of the disclosure, the number of at least one sub-XOR logic may correspond to the maximum number of outputs of the multiplication logic 2100. The at least one sub-XOR logic may be arranged in the same number as the maximum number of at least one output of the multiplication logic 2100. Each of the at least one sub XOR logic may be activated or deactivated according to the datatypes and precisions of the first input value and the second input value.

The XOR logic 2300 may be connected to the normalizer 2400. The XOR logic 2300 may transfer an operation result to the normalizer 2400.

The normalizer 2400 may normalize and output input values. The normalizer 2400 may be deactivated based on the datatypes of the first input value and the second input value being integer types. The normalizer 2400 may normalize the output of the multiplication logic 2100 and the output of the addition logic 2200 based on the datatypes of the first and second input values being floating-point types.

In an embodiment of the disclosure, the normalizer 2400 may include a plurality of sub-normalizers. FIG. 10 shows that the multiplication logic 2100 performs an 8b×8b operation and the normalizer 2400 includes five sub-normalizers, but the disclosure is not limited thereto. For example, one sub-normalizer may correspond to an 8b×8b multiplication operation result, and each of four sub-normalizers may correspond to a 4b×4b multiplication operation result. For example, when the multiplier 2000 performs one 8b×8b floating-point operation, one pre-specified sub-normalizer may be activated, and four unspecified sub-normalizers may be deactivated. For example, when the multiplier 2000 performs four 4b×4b floating-point operations, four pre-specified sub-normalizers may be activated, and one unspecified sub-normalizer may be deactivated.

The rounder 2500 may round off and output input values with a predefined bit width. The rounder 2500 may be deactivated based on the datatypes of the first input value and the second input value being integer types. The rounder 2500 may round off the input values with the predefined bit width by using the output of the normalizer 2400 and the output of the XOR logic 2300, based on the datatypes of the first and second input values being floating-point types. FIG. 10 shows that the multiplication logic 2100 performs an 8b×8b operation and the rounder 2500 includes five sub-rounders, but the disclosure is not limited thereto. Whether the sub-rounders are activated corresponds to whether the sub-normalizers of the normalizer 2400 are activated, and thus, a description thereof is omitted.

The multiplexer MUX may output the output of the multiplication logic 2100 based on the datatypes of the first input value and the second input value being integer types, and output an output of the rounder 2500 based on the datatypes of the first input value and the second input value being integer types.

In an embodiment of the disclosure, the multiplier 2000 may be controlled by a processor (not shown). The processor may obtain the first input value and the second input value. The processor may identify the datatypes and precisions of the first input value and the second input value. The processor may control each structural element of the multiplier 2000 based on the identified datatypes and precisions.

In an embodiment of the disclosure, the multiplier 2000 may perform an N-bit×M-bit multiplication operation. In this case, each of the sub-multiplication logics of the multiplication logic 2100 may perform a (N/p)-bit×(M/q)-bit multiplication operation. In this case, N and M may be natural numbers divided by p and q, respectively. In this case, the multiplier 2000 may support multiplication operations such as (N/p)-bit×(M/q)-bit, (2N/p)-bit×(M/q)-bit, . . . , N-bit×(M/q)-bit, N-bit×(2M/q)-bit, . . . , N-bit×M-bit.

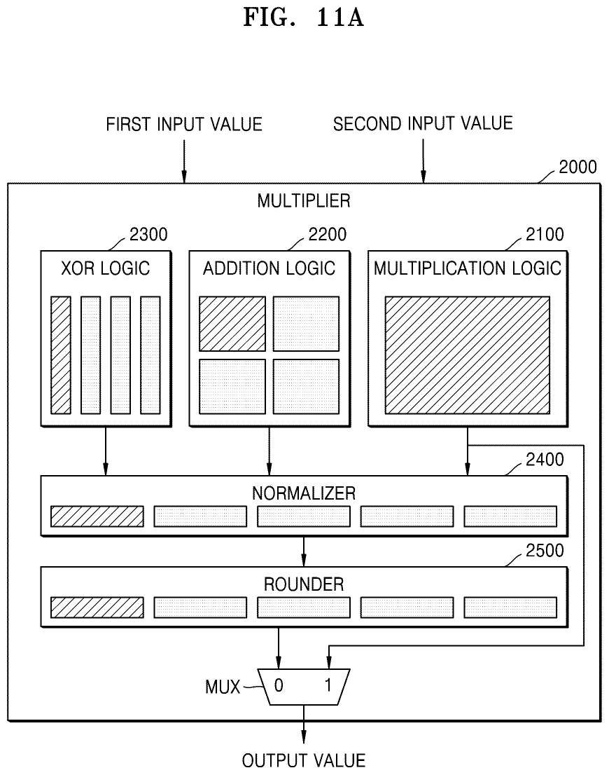

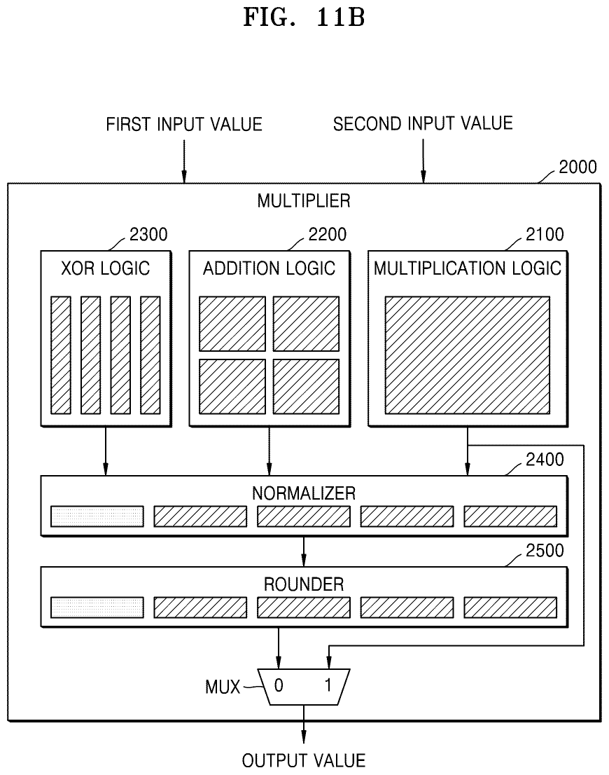

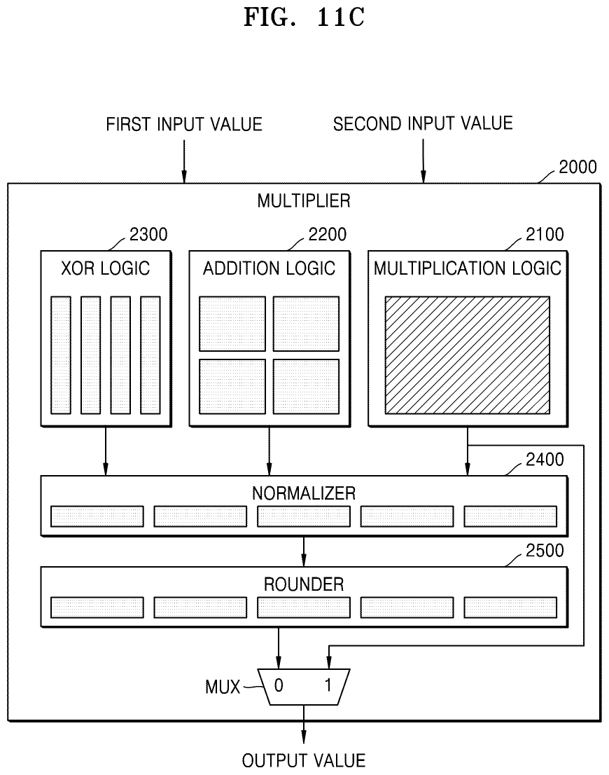

FIGS. 11A to 11C are conceptual diagrams for explaining operations of the multiplier 2000 according to an embodiment of the disclosure. Redundant descriptions given with reference to FIG. 10 are omitted. FIGS. 11A to 11C show that the multiplier 2000 supports an 8b×8b multiplication operation, but the disclosure is not limited thereto, and may support multiplication operations with respect to various bit widths.

Referring to FIG. 11A, it is assumed that a first input value and a second input value have a datatype and precision of bfloat16. bloat16 is a floating-point type, with 1 bit corresponding to a sign, 8 bits corresponding to an exponent, and 7 bits corresponding to a mantissa. Because bloat16 is the floating-point type, the addition logic 2200, the XOR logic 2300, the normalizer 2400, and the rounder 2500 including the multiplication logic 2100 may be activated.

All sub-multiplication logics of the multiplication logic 2100 may be activated. Because the mantissa additionally includes 1 bit as an implicit bit, an operation may be performed on the mantissa with 8 bits rather than 7 bits. The multiplication logic 2100 may output a multiplication operation between the 8-bit mantissa of the first input value and the 8-bit mantissa of the second input value.

Because the multiplication logic 2100 outputs one 8b×8b operation result, one of the sub-addition logics of the addition logic 2200 may be activated. The addition logic 2200 may perform exponential addition between the 8-bit exponent of the first input value and the 8-bit exponent of the second input value, receive a bias value of 2⁽⁸⁾−1, and output a value obtained by subtracting the bias value from an exponential addition result.

Because the multiplication logic 2100 outputs one 8b×8b operation result, one of sub-XOR logics of the XOR logic 2300 may be activated. The XOR logic 2300 may perform an XOR operation between the 1-bit sign of the first input value and the 1-bit sign of the second input value.

Because the multiplication logic 2100 outputs one 8b×8b operation result, one of sub-normalizers of the normalizer 2400 may be activated. The normalizer 2400 may perform normalization on an output of the multiplication logic 2100 and an output of the addition logic 2200.

Because the multiplication logic 2100 outputs one 8b×8b operation result, one of sub-rounders of the rounder 2500 may be activated. The rounder 2500 may receive an output of the normalizer 2400 and an output of the XOR logic 2300. The rounder 2500 may round off the output of the normalizer 2400 with a predefined bit width. The rounder 2500 may connect the output of the XOR logic 2300 to a rounded value and transfer an output to the multiplexer MUX.

The multiplexer MUX may output an output of the rounder 2500 based on the datatypes of the first input value and the second input value being floating-point types.

Referring to FIG. 11B, it is assumed that the first input value and the second input value have a datatype and precision of FP8. FP8 is a floating-point type, with 1 bit corresponding to a sign, 4 bits corresponding to an exponent, and 3 bits corresponding to a mantissa. Accordingly, the first input value may include four FP8 floating-point values, and the second input value may include four FP8 floating-point values. Because FP8 is the floating-point type, the addition logic 2200, the XOR logic 2300, the normalizer 2400, and the rounder 2500 including the multiplication logic 2100 may be activated.

All sub-multiplication logics of the multiplication logic 2100 may be activated. Because the mantissa additionally includes 1 bit as an implicit bit, an operation may be performed on the mantissa with 4 bits rather than 3 bits. Each of the activated sub-multiplication logics may output a multiplication operation between the 4-bit mantissa of each of the four FP8 values included in the first input value and the 4-bit mantissa of each of the four FP8 values included in the second input value.

Because the multiplication logic 2100 outputs four 4b×4b operation results, four of sub-addition logics of the addition logic 2200 may be activated. Each of the activated sub-addition logics may perform exponential addition between the 4-bit exponent of each of the four FP8 values included in the first input value and the 4-bit exponent of each of the four FP8 values included in the second input value, receive a bias value of 22⁽⁴⁾−1, and output a value obtained by subtracting the bias value from an exponential addition result.

Because the multiplication logic 2100 outputs four 4b×4b operation results, four of sub-XOR logics of the XOR logic 2300 may be activated. Each of the activated sub-XOR logics may perform an XOR operation between the 1-bit sign of each of the four FP8 values included in the first input value and the 1-bit sign of each of the four FP8 values included in the second input value.

Because the multiplication logic 2100 outputs four 4b×4b operation results, four of the sub-normalizers of the normalizer 2400 may be activated. The normalizer 2400 may perform normalization on an output of the multiplication logic 2100 and an output of the addition logic 2200.

Because the multiplication logic 2100 outputs four 4b×4b operation results, four of the sub-rounders of the rounder 2500 may be activated. The rounder 2500 may receive an output of the normalizer 2400 and an output of the XOR logic 2300. The rounder 2500 may round off the output of the normalizer 2400 with a predefined bit width. The rounder 2500 may connect the output of the XOR logic 2300 to a rounded value and transfer an output to the multiplexer MUX.

The multiplexer MUX may output an output of the rounder 2500 based on the datatypes of the first input value and the second input value being floating-point types.

Referring to FIG. 11C, it is assumed that the first input value and the second input value have a datatype and precision of INT8. INT8 is an integer datatype with a bit width of 8 bits. Because INT8 is an integer type, only the multiplication logic 2100 may be activated, and the addition logic 2200, the XOR logic 2300, the normalizer 2400, and the rounder 2500 may be deactivated.

All sub-multiplication logics of the multiplication logic 2100 may be activated. The multiplication logic 2100 may output a multiplication operation between the 8-bit integer corresponding to the first input value and the 8-bit integer corresponding to the second input value by using the sub-multiplication logics.

The multiplexer MUX may output an output of the multiplication logic 2100 based on the datatypes of the first input value and the second input value being integer types.

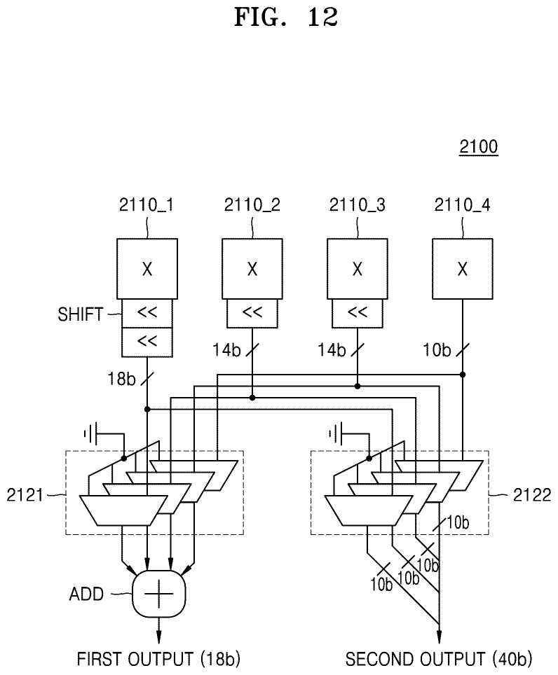

FIG. 12 is a block diagram for explaining the configuration of the multiplication logic 2100 according to an embodiment of the disclosure. Redundant descriptions given with reference to FIGS. 10 to 11C are omitted.

Referring to FIG. 10 along with FIG. 12, the multiplication logic 2100 may include four sub-multiplication logics 2110_1, 2110_2, 2110_3, and 2110_4. However, the disclosure is not limited thereto, and the multiplication logic 2100 may include fewer or more than four sub-multiplication logics.

Each of the sub-multiplication logics 2110_1, 2110_2, 2110_3, and 2110_4 may be implemented as a 4b×4b multiplier or a 5b×5b multiplier including a sign bit. FIG. 12 shows that each of the sub-multiplication logics 2110_1, 2110_2, 2110_3, and 2110_4 performs the 5b×5b multiplication operation, but the disclosure is not limited thereto.

Each of the sub-multiplication logics 2110_1, 2110_2, 2110_3, and 2110_4 may include at least one shifter logic SHIFT. The shifter logic may shift an output of each of the sub-multiplication logics 2110_1, 2110_2, 2110_3, and 2110_4 by a predefined number of bits. For example, the shifter logic SHIFT may perform 4-bit left shifting. However, the disclosure is not limited thereto, and shifting bits and/or shifting direction of the shifter logic SHIFT may vary.

In an embodiment of the disclosure, two shifter logics may be connected to the first sub-multiplication logic 2110_1. The two shifter logics may perform left shifting on an output of the first sub-multiplication logic 2110_1 by 8 bits. One shifter logic may be connected to the second sub-multiplication logic 2110_2. One shifter logic may perform left shifting on an output of the second sub-multiplication logic 2110_2 by 4 bits. One shifter logic may be connected to the third sub-multiplication logic 2110_3. The one shifter logic may perform left shifting on an output of the third sub-multiplication logic 2110_3 by 4 bits.

In an embodiment of the disclosure, the multiplication logic 2100 may include a first multiplexer logic 2121 and a second multiplexer logic 2122. Each of the sub-multiplication logics 2110_1, 2110_2, 2110_3, and 2110_4 may be connected to the first multiplexer logic 2121 and the second multiplexer logic 2122.

The first multiplexer logic 2121 may receive a control signal indicating whether summation of the outputs of the sub-multiplication logics 2110_1, 2110_2, 2110_3, and 2110_4 is necessary based on precisions and datatypes of the values input to the multiplication logic 2100. The first multiplexer logic 2121 may transfer an output of the multiplication logic 2100 to the selective adder ADD based on the control signal indicating that summation of the outputs of the sub-multiplication logics 2110_1, 2110_2, 2110_3, and 2110_4 is necessary. The selective adder ADD may output a first output of 18 bits by summing the outputs of the sub-multiplication logics 2110_1, 2110_2, 2110_3, and 2110_4.

The multiplexer logic 2121 may output a second output of 40 bits that is a set of the outputs of the sub-multiplication logics 2110_1, 2110_2, 2110_3, and 2110_4, based on the control signal indicating that summation of the outputs of the sub-multiplication logics 2110_1, 2110_2, 2110_3, and 2110_4 is unnecessary.

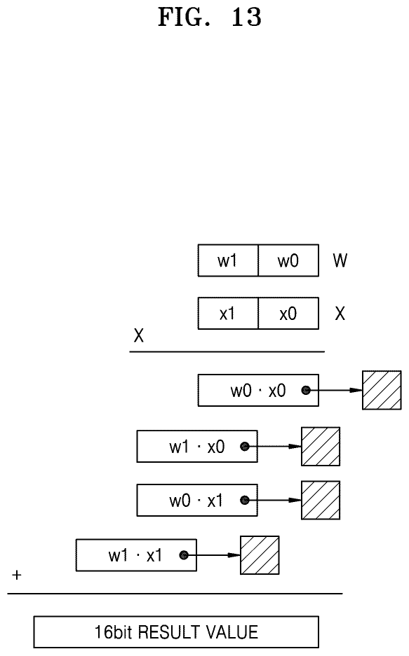

FIG. 13 is a conceptual diagram illustrating a multiplication operation according to an embodiment of the disclosure.

Referring to FIG. 12 along with FIG. 13, it is assumed that a weight value W is 8 bits and an input value X is 8 bits. The weight value W may be divided into a 4-bit first weight sub-word w0 and a 4-bit second weight sub-word w1. The input value X may be divided into a 4-bit first input sub-word x0 and a 4-bit second input sub-word x1. To perform a multiplication operation between 8 bits and 8 bits, a 16-bit result value may be obtained by performing a multiplication operation between 4-bit sub-words and then performing shifting and summation.

For example, the fourth sub-multiplication logic 2110_4 may obtain a first result value by performing multiplication between the first weight sub-word w0 and the first input sub-word x0. The third sub-multiplication logic 2110_3 may obtain a second result value by performing multiplication between the second weight sub-word w1 and the first input sub-word x0. The second sub-multiplication logic 2110_2 may obtain a third result value by performing multiplication between the first weight sub-word w0 and the second input sub-word x1. The first sub-multiplication logic 2110_1 may obtain a fourth result value by performing multiplication between the second weight sub-word w1 and the second input sub-word x1. A shifter logic may perform left shifting on the second result value and the third result value by 4 bits. The shifter logic may perform left shifting on the fourth result value by 8 bits.

The multiplication logic 2100 may output a 16-bit result value based on the first result value and shifted second to fourth result values.

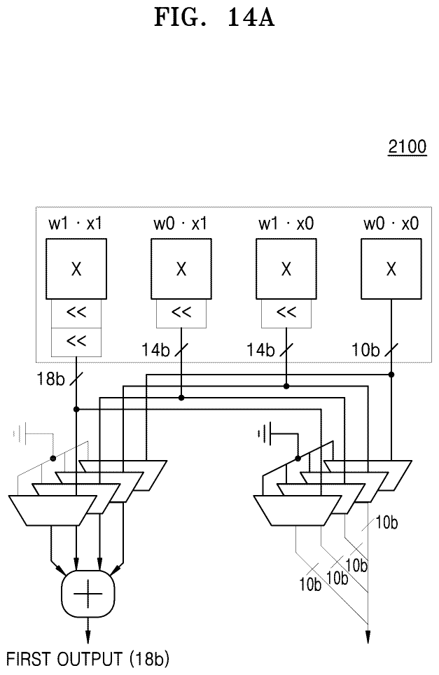

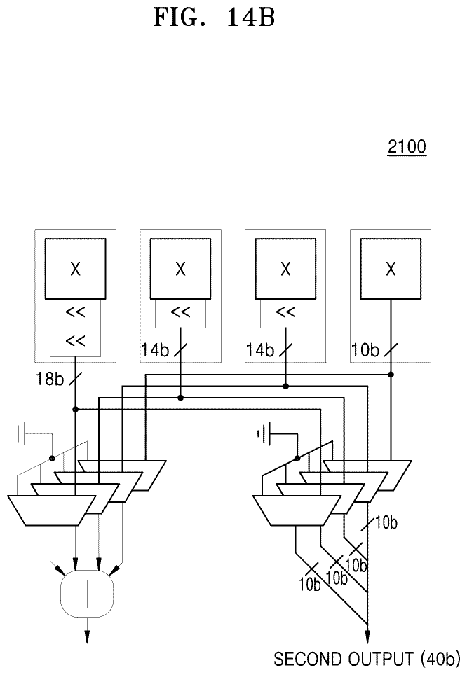

FIGS. 14A and 14B are block diagrams for explaining operations of a multiplication operation according to an embodiment of the disclosure. Redundant descriptions given with reference to FIGS. 10 to 13 are omitted.

Referring to FIG. 14A, it is assumed that the multiplication logic 2100 performs a multiplication operation between a first input value of INT8 and a second input value of INT8. Each of sub-multiplication logics may perform a multiplication operation between 4-bit sub-words. At least one shifting logic may shift at least a part of the multiplication operation by 4 bits or 8 bits. When a datatype of an input value is INT8, a selective adder is activated, and result values of the sub-multiplication logics may be summed and output.

In an embodiment of the disclosure, it is assumed that the multiplication logic 2100 performs the multiplication operation between a first input value of bfloat16 and a second input value of bfloat16. Each of the sub-multiplication logics may perform the multiplication operation between 4-bit sub-words among mantissa values of the 8-bit bfloat16. The at least one shifting logic may shift at least a part of the multiplication operation by 4 bits or 8 bits. When the datatype of the input value is bfloat16, the selective adder may be activated, and the result values of the sub-multiplication logic may be summed and output. However, the disclosure is not limited thereto, and the selective adder may be deactivated by predefined settings, regardless of the datatype of the input value.

Referring to FIG. 14B, it is assumed that the multiplication logic 2100 performs a multiplication operation between a first input value of INT4 and a second input value of INT4. Each of sub-multiplication logics may perform a multiplication operation between one of a plurality of 4-bit INT4 integer values included in the first input value and one of a plurality of 4-bit INT4 integer values included in the second input value. At least one shifting logic may be deactivated. When the datatype of the input value is IN4, the selective adder is deactivated, and result values of the sub-multiplication logics may be output without being summed.

In an embodiment of the disclosure, it is assumed that the multiplication logic 2100 performs a multiplication operation between a first input value of FP8 and a second input value of FP8. Each of the sub-multiplication logics may perform a multiplication operation between one of a plurality of 4-bit FP8 mantissa values included in the first input value and one of a plurality of 4-bit FP8 mantissa values included in the second input value. At least one shifting logic may be deactivated. When the datatype of the input value is FP8, the selective adder is deactivated, and result values of the sub-multiplication logics may be output without being summed. However, the disclosure is not limited thereto, and the selective adder may be activated by predefined settings, regardless of the datatype of the input value.

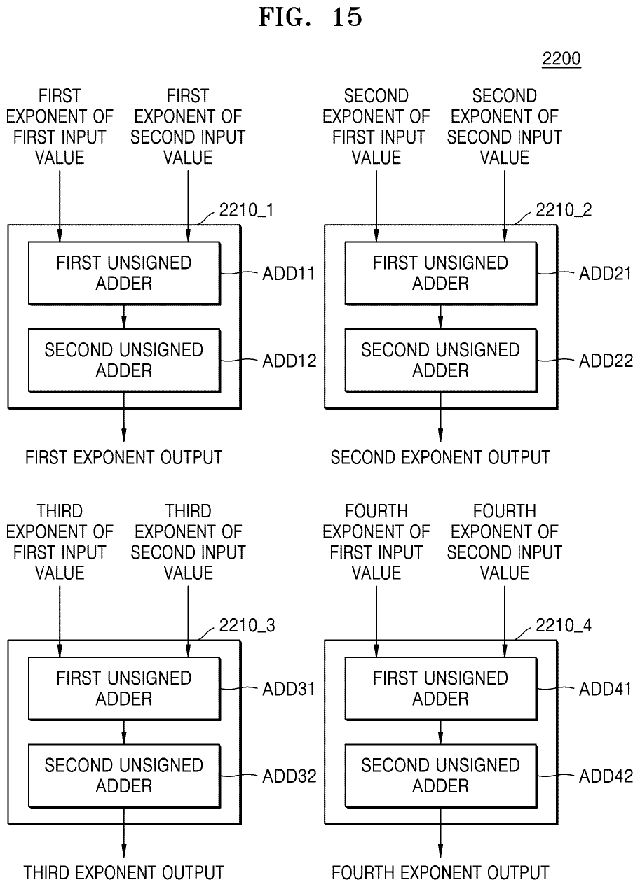

FIG. 15 is a block diagram for explaining the configuration of the addition logic 2200 according to an embodiment of the disclosure. Redundant descriptions given with reference to FIGS. 10 to 14B are omitted.

Referring to FIG. 10 along with FIG. 15, the addition logic 2200 may include four sub-addition logics 2210_1, 2210_2, 2210_3, and 2210_4. However, the disclosure is not limited thereto, and the addition logic 2200 may include fewer or more than four sub-addition logics.

Each of a first input value and a second input value may include at least one exponent according to a datatype and precision thereof. For example, when datatypes and precisions of the first input value and the second input value are bfloat 16, each of the first input value and the second input value may include one exponent. In this case, only the first sub-addition logic 2210_1 may be activated.

For example, when the datatypes and precisions of the first input value and the second input value are FP8, each of the first input value and the second input value may include four exponents (e.g., first to fourth exponents). In this case, the first to fourth sub-addition logics 2210_1, 2210_2, 2210_3, and 2210_4 may be activated.

For convenience of description, the configuration, operation, and function of the first sub-addition logic 2210_1 are mainly described below.

The first sub-addition logic 2210_1 may include a first unsigned adder ADD11 and a second unsigned adder ADD12. In an embodiment of the disclosure, the first unsigned adder ADD11 and the second unsigned adder ADD12 may each be implemented as a CSA, but the disclosure is not limited thereto.

The first unsigned adder ADD11 may receive a first exponent of the first input value and a first exponent of the second input value. The first unsigned adder ADD11 may sum the first exponent of the first input value and the first exponent of the second input value. The first unsigned adder ADD11 may transfer a summation result to the second unsigned adder ADD12.

The second unsigned adder ADD12 may subtract a predefined bias value from the summation result. The bias value may vary depending on the precisions and datatypes of the first input value and the second input value. The second unsigned adder ADD12 may output a subtraction result (e.g., first exponent output).

The configuration, operation, and function of the first sub-addition logic 2210_1 may respectively correspond to the configuration, operation, and function of each of the second to fourth sub-addition logics 2210_2 to 2210_4. The configuration, operation, and function of each of the first unsigned adder ADD11 and the second unsigned adder ADD12 may respectively correspond to the configuration, operation, and function of each of first unsigned adders ADD21, ADD31, and ADD41 and second unsigned adders ADD22, ADD32, and ADD42 of the second to fourth sub-addition logics 2210_2 to 2210_4.

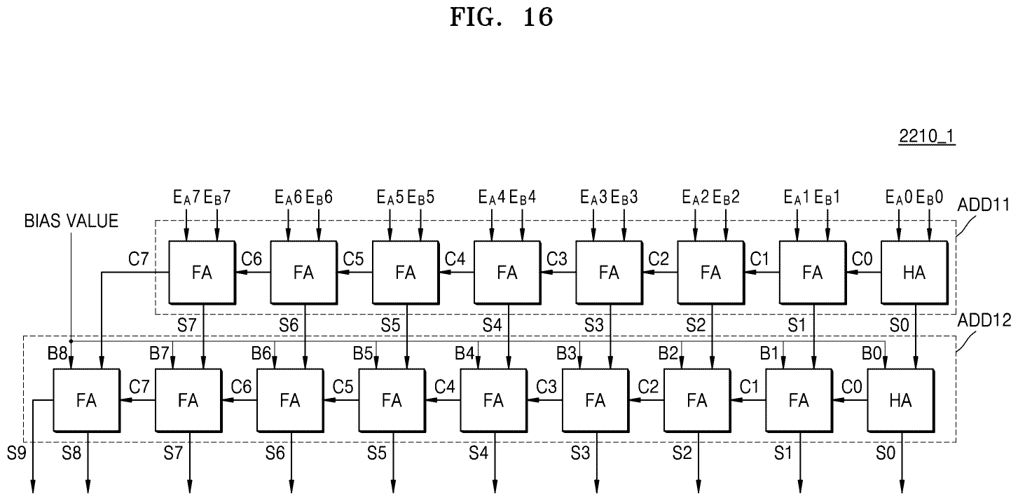

FIG. 16 is a block diagram for explaining the configuration of the first sub-addition logic 2210_1 according to an embodiment of the disclosure. Redundant descriptions given with reference to FIGS. 10 to 15 are omitted. For convenience of description, the configuration of the first sub-addition logic 2210_1 in FIG. 15 among sub-addition logics is described as an example.

Referring to FIG. 15 together with FIG. 16, the first unsigned adder ADD11 may include a plurality of full adders FA and a half adder HA. FIG. 16 shows that the first unsigned adder ADD11 includes 7 full adders FA, but the disclosure is not limited thereto, and the first unsigned adder ADD11 may include fewer or more the 7 full adders FA.

According to an embodiment of the disclosure, as the number of full adders FA increases, the precision of an exponent that may be processed by the first sub-addition logic 2210_1 may increase. When the sum of the number of full adders FA and the number of half adders HA included in the first unsigned adder ADD11 is N, the first sub-multiplication logic 2210_1 in FIG. 15 may support an addition operation on exponents of N bits or less. For example, a combination of the plurality of full adders FA and half adders HA shown in FIG. 16 may support addition operations on exponents of 8 bits or less.

The half adder HA may output a first carry bit C0 and a first summation bit S0 by using a first bit EA0 of a first exponent of a first input value and a first bit EB0 of a first exponent of a second input value as inputs.

Each of the plurality of full adders FA may output a next carry bit and a next summation bit by using a previous carry bit, a predefined bit of the first exponent of the first input value, and a predefined bit of the first exponent of the second input value.

The plurality of full adders FA may include first to seventh full adders. For example, the first full adder may output a second carry bit C1 and a second summation bit S1 by using the first carry bit C0, a second bit EA1 of the first exponent of the first input value, and a second bit EB1 of the first exponent of the second input value as inputs. For example, the second full adder may output a third carry bit C2 and a third summation bit S2 by using the second carry bit C1, a third bit EA2 of the first exponent of the first input value, and a third bit EB2 of the first exponent of the second input value as inputs. For example, the third full adder may output a fourth carry bit C3 and a fourth summation bit S3 by using the third carry bit C2, a fourth bit EA3 of the first exponent of the first input value, and a fourth bit EB3 of the first exponent of the second input value as inputs. For example, the fourth full adder may output a fifth carry bit C4 and a fifth summation bit S4 by using the fourth carry bit C3, a fifth bit EA4 of the first exponent of the first input value, and a fifth bit EB4 of the first exponent of the second input value as inputs. For example, the fifth full adder may output a sixth carry bit C5 and a sixth summation bit S5 by using the fifth carry bit C4, a sixth bit EA5 of the first exponent of the first input value, and a sixth bit EB5 of the first exponent of the second input value as inputs. For example, the sixth full adder may output a seventh carry bit C6 and a seventh summation bit S6 by using the sixth carry bit C5, a seventh bit EA6 of the first exponent of the first input value, and a seventh bit EB6 of the first exponent of the second input value as inputs. For example, the seventh full adder may output an eighth carry bit C7 and an eighth summation bit S7 by using the seventh carry bit C6, an eighth bit EA7 of the first exponent of the first input value, and an eighth bit EB7 of the first exponent of the second input value as inputs.

The second unsigned adder ADD12 may include the plurality of full adders FA and the half adder HA. FIG. 16 shows that the second unsigned adder ADD12 includes 8 full adders FA, but the disclosure is not limited thereto, and the first unsigned adder ADD11 may include fewer or more the 8 full adders FA. The second unsigned adder ADD12 may include one more full adder FA than the first unsigned adder ADD11.

The half adder HA of the second unsigned adder ADD12 may output the first carry bit C0 and the first summation bit S0 by using the first summation bit S0 output by the half adder HA of the first unsigned adder ADD11 and the first bit B0 of a bias value as inputs. The first summation bit S0 output by the half adder HA of the first unsigned adder ADD11 and the first summation bit S0 output by the half adder HA of the second unsigned adder ADD12 may refer to different bits.

Each of the plurality of full adders FA may output a next carry bit and a next summation bit by using a previous carry bit, a predefined bit of the bias value, and a corresponding summation bit among summation bits output by the full adders FA of the first unsigned adder ADD11 as inputs.

The plurality of full adders FA may include eighth to fifteenth full adders. For example, the eighth full adder may output the second carry bit C1 and the second summation bit S1 by using the first carry bit C0, the second summation bit S1 output by the first full adder, and a second bit B1 of the bias value as inputs. For example, the ninth full adder may output the third carry bit C2 and the third summation bit S2 by using the second carry bit C1, third summation bit S2 output by the second full adder, and a third bit B2 of the bias value as inputs. For example, the tenth full adder may output the fourth carry bit C3 and the fourth summation bit S3 by using third carry bit C2, the fourth summation bit S3 output by the third full adder, and a fourth bit B3 of the bias value as inputs. For example, the eleventh full adder may output the fifth carry bit C4 and the fifth summation bit S4 by using the fourth carry bit C3, the fifth summation bit S4 output by the fourth full adder, and a fifth bit B4 of the bias value as inputs. For example, the twelfth full adder may output the sixth carry bit C5 and the sixth summation bit S5 by using the fifth carry bit C4, the sixth summation bit S5, and a sixth bit B5 of the bias value as inputs. For example, the thirteenth full adder may output the seventh carry bit C6 and the seventh summation bit S6 by using the sixth carry bit C5, the seventh summation bit S6, and a seventh bit B6 of the bias value as inputs. For example, the fourteenth full adder may output the eighth carry bit C7 and the eighth summation bit S7 by using the seventh carry bit C6, the eighth summation bit S7, and an eighth bit B7 of the bias value as inputs. For example, the fifteenth full adder may output a ninth summation bit S8 and a tenth summation bit S9 by using the eighth carry bit C7, the eighth carry bit C7 output by the seventh full adder, and a ninth bit B8 of the bias value as inputs.

The summation bits S0 to S9, which are outputs of the second unsigned adder ADD12 may be used as output values of the addition logic 2200 with the first exponent of the first input value and the second exponent of the second input value as inputs.

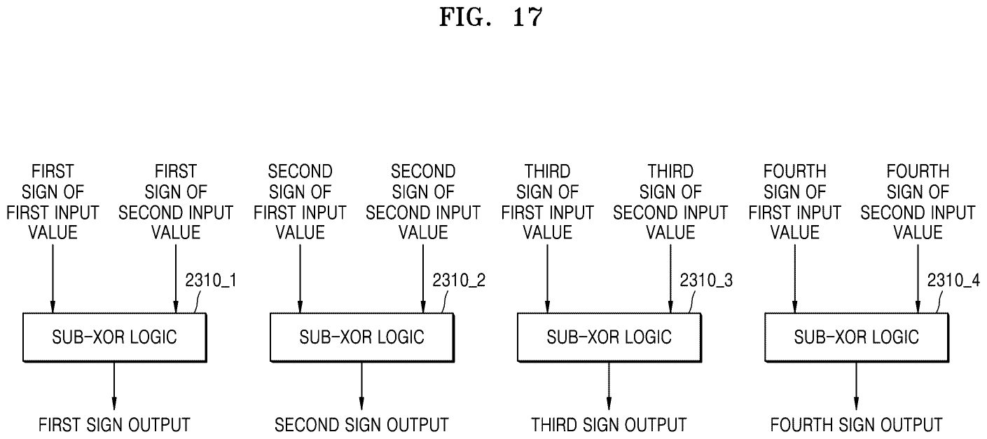

FIG. 17 is a block diagram for explaining the configuration of the XOR logic 2300 according to an embodiment of the disclosure. Redundant descriptions given with reference to FIGS. 10 to 16 are omitted.

Referring to FIG. 10 along with FIG. 16, the XOR logic 2300 may include four sub-XOR logics 2310_1, 2310_2, 2310_3, and 2310_4. However, the disclosure is not limited thereto, and the XOR logic 2300 may include fewer or more than four sub-XOR logics.

Each of a first input value and a second input value may include at least one sign according to a datatype and precision thereof. For example, when datatypes and precisions of the first input value and the second input value are bfloat 16, each of the first input value and the second input value may include one sign. In this case, only the first sub-XOR logic 2310_1 may be activated.

For example, when the datatypes and precisions of the first input value and the second input value are FP8, each of the first input value and the second input value may include four signs (e.g., first to fourth signs). In this case, the first to fourth sub XOR logics 2310_1, 2310_2, 2310_3, and 2310_4 may be activated.

For convenience of description, the configuration, operation, and function of the first sub-XOR logic 2310_1 are mainly described below.

The first sub XOR logic 2310_1 may receive a first sign of the first input value and a first sign of the second input value. The first sub XOR logic 2310_1 may perform an XOR operation by using the first sign of the first input value and the first sign of the second input value. For example, when a bit corresponding to the first sign of the first input value and a bit corresponding to the first sign of the second input value are the same, the first sub XOR logic 2310_1 may output the first value, and when the bit corresponding to the first sign of the input value and the bit corresponding to the first sign of the second input value are different, the first sub XOR logic 2310_1 may output the second value. For example, when the first sign of the first input value represents a positive number, and the first sign of the second input value represents a positive number, the first sub-XOR logic 2310_1 may output a sign value representing a positive number. For example, when the first sign of the first input value represents a positive number and the first sign of the second input value represents a negative number, the first sub-XOR logic 2310_1 may output a sign value representing a negative number.

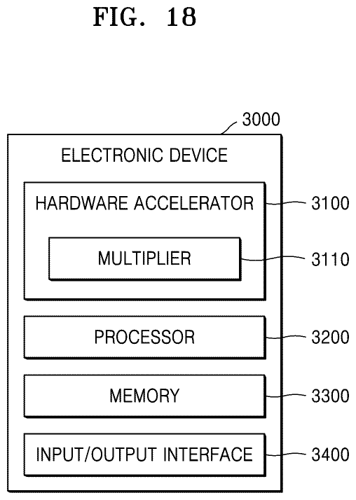

FIG. 18 is a block diagram for explaining the configuration of an electronic device 3000 according to an embodiment of the disclosure. Redundant descriptions given with reference to FIGS. 10 to 17 are omitted.

Referring to FIG. 18, the electronic device 3000 may include a hardware accelerator 3100, a processor 3200, a memory 3300, and an input/output interface 3400. However, structural elements of the electronic device 3000 are not limited to the above-described examples, and the electronic device 3000 may include more structural elements or fewer structural elements than the above-described structural elements.

In an embodiment of the disclosure, at least some of the hardware accelerator 3100, the processor 3200, the memory 3300, and the input/output interface 3400 may be implemented in the form of a single chip, and the processor 3200 may include one or more processors. The electronic device 3000 may be a device such as a PC, laptop, or server, as well as a mobile device such as a smartphone.

The configuration, function, and operation of the hardware accelerator 3100 may respectively correspond to the configuration, function, and operation of the hardware accelerator 1000 described with reference to FIG. 1. Therefore, redundant descriptions given with reference to FIG. 1 are omitted

The hardware accelerator 3100 may perform a matrix operation between a first tensor (e.g., an input tensor) and a second tensor (e.g., a weight tensor) by using a plurality of MAC operators.

The hardware accelerator 3100 may perform learning or inference of a DNN model under the control of the processor 3200. The hardware accelerator 3100 may read data (e.g., the first tensor and the second tensor) stored in the memory 3300 to perform an operation. An operation result of the hardware accelerator 3100 may be stored in the memory 3300.

In an embodiment of the disclosure, the hardware accelerator 3100 may operate in a first operation mode in which operation results of the plurality of MAC operators are output without being accumulated in a direction of an input channel, or the operation results of the plurality of MAC operators are accumulated in the direction of the input channel output and the accumulated operation results are output.

The processor 3200 is configured to control a series of processes to operate the hardware accelerator 3100 according to the embodiments described with reference to FIGS. 1 to 17, and may include one or more processors. At this time, the one or more processors may be general-purpose processors such as a CPU, an AP, or a digital signal processor (DSP).

The processor 3200 may write data to the memory 3300 or read data stored in the memory 3300, and in particular, execute a program stored in the memory 3300 to process data according to predefined operation rules or a DNN model. In an embodiment, the processor 2320 may control the hardware accelerator 3100 based on DNN information including at least one of the number of layers of the DNN, types of layers, shapes of tensors, dimensions of tensors, operation modes, bit precisions, types of batch normalizations, types of pooling layers, or types of ReLU functions.

In an embodiment of the disclosure, the processor 3200 may control the hardware accelerator 3100 to perform an operation of at least one DNN based on a user input. The processor 3200 may control the hardware accelerator 3100 to perform an operation of at least one DNN model based on a plurality of user inputs. When an operation on the same DNN model is requested from another user, the processor 3200 may allow the hardware accelerator 3100 to simultaneously perform operations on the same DNN models based on user inputs corresponding to the user request. According to an embodiment of the disclosure, in a multitenant environment, the hardware accelerator 3100 may simultaneously process requests from other users with respect to operations of the same DNN model by grouping or not grouping MAC operators of the MAC array.

In an embodiment of the disclosure, the hardware accelerator 3100 may include a multiplier 3110. The configuration, function, and operation of the multiplier 3110 may respectively correspond to the configuration, function, and operation of the multiplier 2000 described with reference to FIG. 10. Therefore, redundant descriptions given with reference to FIG. 10 are omitted

An operation of the multiplier 3110 may be controlled by the processor 3200. The processor 3200 may obtain a first input value and a second input value from the input/output interface 3400 or the memory 3300. The processor 3200 may identify datatypes and precisions of the first input value and the second input value. For example, the datatype may be an integer type or a floating-point type, but the disclosure is not limited thereto. For example, the precision may indicate a bit width of the first input value or the second input value. For example, the first input value and/or the second input value may be INT4, INT8, bfloat16, FP8, FP32, etc., but the disclosure is not limited thereto, and the first input value and/or the second input value may have various datatypes and/or precisions.

In an embodiment of the disclosure, the processor 3200 may distribute bits of the first input value and bits of the second input value to sub-multiplication logics of multiplication logic of the multiplier 3100, based on the identified datatypes and precisions. The processor 3200 may obtain at least one output of the multiplication logic based on outputs of the sub-multiplication logic.

In an embodiment of the disclosure, the processor 3200 may determine whether to activate at least one shifting logic of the multiplication logic based on the identified datatypes and precisions. The at least one activated shifting logic may shift at least one of the outputs of the sub-multiplication logics.

In an embodiment of the disclosure, the processor 3200 may determine whether to activate a selective adder of the multiplication logic based on the identified datatypes and precisions. The activated selective adder may sum the outputs of the sub-multiplication logics.

In an embodiment of the disclosure, the processor 3200 may distribute bits corresponding to a mantissa of the first input value to the sub-multiplication logics, based on the identified datatypes being floating-point types. The processor 3200 may distribute bits corresponding to a mantissa of the second input value to the sub-multiplication logics, based on the identified datatypes being integer types.

In an embodiment of the disclosure, the processor 3200 may determine whether to activate an addition logic of the multiplier 3110 based on the identified datatypes and precisions. The activated addition logic may sum bits corresponding to an exponent of the second input value and bits corresponding to an exponent of the first input value. The activated addition logic may subtract bias values mapped to the identified datatypes and precisions from a summation result.

In an embodiment of the disclosure, the processor 3200 may determine whether to activate an XOR logic of the multiplier 3110 based on the identified datatypes and precisions. The activated XOR logic may perform an XOR operation between a bit corresponding to a sign of the first input value and a bit corresponding to a sign of the second input value.

In an embodiment of the disclosure, the processor 3200 may determine whether to activate a normalizer based on the identified datatypes and precisions. The activated normalizer may normalize at least one output of the multiplication logic and at least one output of the addition logic.

In an embodiment of the disclosure, the processor 3200 may determine whether to activate a rounder based on the identified datatypes and precisions. The activated rounder may perform rounding with a predefined bit width by using at least one output of the XOR logic and at least one output of the normalizer.

In an embodiment of the disclosure, the processor 3200 may determine at least one output of the multiplication logic to be the output of the multiplier 3110, based on the identified datatypes being integer types. The processor 3200 may determine the output of the normalizer to be the output of the multiplier 3110, based on the fact that the identified datatypes being floating-point types.

The hardware accelerator 3100, the multiplier 3110, and the processor 3200 may perform operations described in the above-described embodiments, and the operations that are described as being performed by the electronic device 3000 in the above-described embodiments may be regarded as being performed by the hardware accelerator 3100, the multiplier 3110, and the processor 3200 unless otherwise stated.

The memory 3300 is configured to store various programs or data, and may include storage media such as ROM, RAM, hard disk, CD-ROM, and DVD, or a combination of storage media. The memory 3300 may not be present separately but may be included in the processor 3200 or the hardware accelerator 3100. The memory 3300 may be configured as volatile memory, non-volatile memory, or a combination of volatile memory and non-volatile memory. Programs for performing operations performed by the hardware accelerator 3100 or the processor 3200 may be stored in the memory 3300. The memory 3300 may provide stored data to the hardware accelerator 3100 or the processor 3200 according to a request from the hardware accelerator 3100 or the processor 3200. In an embodiment, the memory 3300 may store at least one instruction executed by the processor 3200. The memory 3300 may store parameters or hyperparameters used to learn or infer a DNN.

The input/output interface 3400 may include an input interface (e.g., a touch screen, a hard button, a microphone, etc.) for receiving control commands or information from a user, and an output interface (e.g., a display panel, a speaker, etc.) for displaying an execution result of an operation under the user's control or a state of the electronic device 3000. In an embodiment of the disclosure, the electronic device 3000 may receive hyperparameters of the DNN model and/or a user input requesting an operation of the DNN model from the hardware accelerator 3100 through the input/output interface 3400

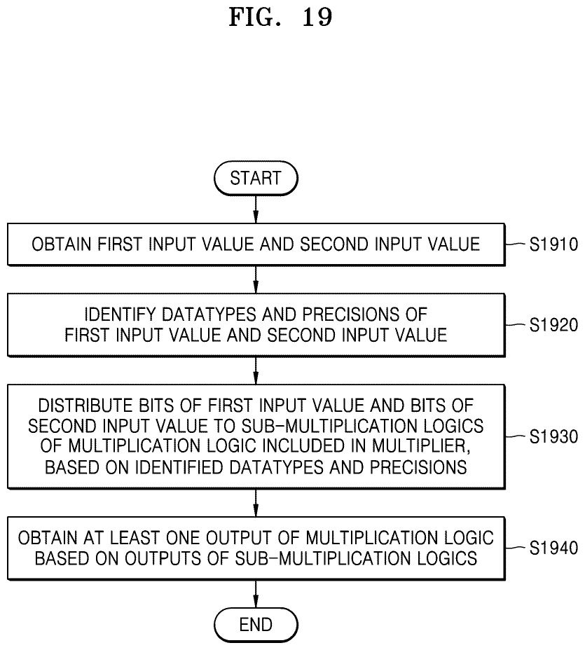

FIG. 19 is a flowchart for explaining the operation of a multiplier according to an embodiment of the disclosure. Redundant descriptions given with reference to FIGS. 10 to 18 are omitted.

In an embodiment of the disclosure, operations S1910 to S1940 may be performed by at least one of the electronic device 3000, the multiplier 3110, the hardware accelerator 3100, and the processor 3200 of FIG. 18. However, the disclosure is not limited thereto, and operations S1910 to S1940 may be performed by any electronic device. An operating method of the multiplier or a controlling method of the multiplier according to an embodiment of the disclosure is not limited to that shown in FIG. 19, may omit at least one of the operations shown in FIG. 19, and may further include an operation not shown in FIG. 19.

In operation S1910, the electronic device 3000 may obtain a first input value and a second input value. In an embodiment of the disclosure, each of the first input value and the second input value may include a plurality of bits having the same datatype and precision. For example, the first input value may correspond to training data or inference target data. The first input value may represent a specific value of an input tensor. For example, the second input value may correspond to weight data. The second input value may represent a specific value of a weight tensor.

In operation S1920, the electronic device 3000 may identify datatypes and precisions of the first input value and the second input value. The electronic device 3000 may transfer a control signal mapped according to the datatypes and precisions of the first input value and the second input value to the multiplier. The multiplier may distribute data to components of the multiplier and/or activate/deactivate the components of the multiplier based on the control signal.

In operation S1930, the electronic device 3000 may distribute bits of the first input value and bits of the second input value to sub-multiplication logics of multiplication logic included in the multiplier, based on the identified datatypes and precisions. In an embodiment of the disclosure, the sub-multiplication logics may perform a 4b×4b multiplication operation that does not process signs, or a 5b×5b multiplication operation that processes signs.

In operation S1940, the electronic device 3000 may obtain at least one output of the multiplication logic based on outputs of the sub-multiplication logics. In an embodiment of the disclosure, the electronic device 3000 may perform shifting on at least one of the outputs of sub-multiplication logics. In an embodiment of the disclosure, the electronic device 3000 may sum the outputs of sub-multiplication logics.

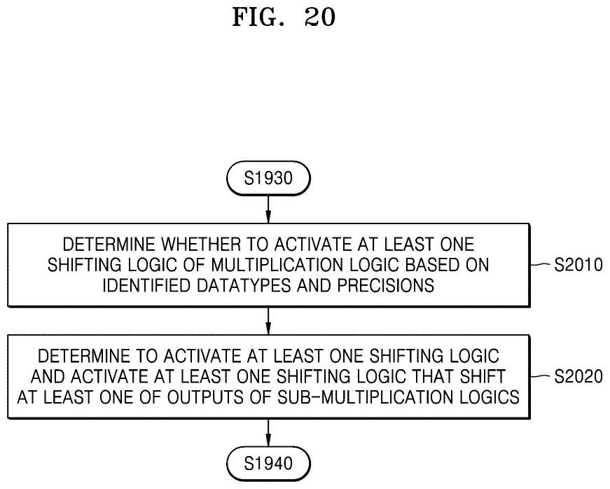

FIG. 20 is a flowchart for explaining the operation of shifting logic according to an embodiment of the disclosure. Redundant descriptions given with reference to FIGS. 10 to 19 are omitted.

In an embodiment of the disclosure, operations S2010 and S2020 may be performed by at least one of the electronic device 3000, the multiplier 3110, the hardware accelerator 3100, and the processor 3200 of FIG. 18. However, the disclosure is not limited thereto, and operations S2010 and S2020 may be performed by any electronic device. An operating method of the shifting logic or a controlling method of the shifting logic according to an embodiment of the disclosure is not limited to that shown in FIG. 20, may omit at least one of the operations shown in FIG. 20, and may further include an operation not shown in FIG. 20.

In an embodiment of the disclosure, operations S2010 and S2020 may be performed by the electronic device 3000 between operations S1930 and S1940 of FIG. 19. However, the time at which operations S2010 and S2020 are performed is not limited thereto.

In operation S2010, the electronic device 3000 may determine whether to activate at least one shifting logic of a multiplication logic based on identified datatypes and precisions. The electronic device 3000 may determine whether to activate the at least one shifting logic mapped to the identified datatypes and precisions. The electronic device 3000 may activate or deactivate the at least one shifting logic that shifts outputs of sub-multiplication logics according to an identification result.

In operation S2020, the electronic device 3000 may determine to activate the at least one shifting logic and activate the at least one shifting logic that shifts at least one of the outputs of the sub-multiplication logics. In an embodiment of the disclosure, the activated shifting logic may perform left shifting on the outputs of the sub-multiplication logics by a predefined bit width. In an embodiment of the disclosure, the electronic device 3000 may obtain the output of the multiplication logic based on the shifted or unshifted outputs of the sub-multiplication logics.

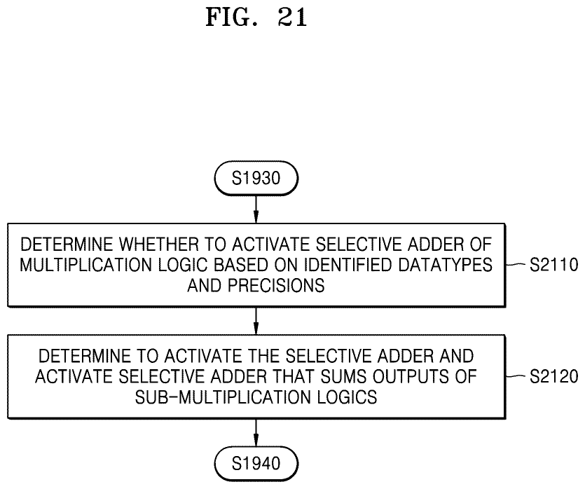

FIG. 21 is a flowchart for explaining the operation of a selective adder according to an embodiment of the disclosure. Redundant descriptions given with reference to FIGS. 1 to 20 are omitted.

In an embodiment of the disclosure, operations S2110 and S2120 may be performed by at least one of the electronic device 3000, the multiplier 3110, the hardware accelerator 3100, and the processor 3200 of FIG. 18. However, the disclosure is not limited thereto, and operations S2110 and S2120 may be performed by any electronic device. An operating method of the selective adder or a controlling method of the selective adder according to an embodiment of the disclosure is not limited to that shown in FIG. 21, may omit at least one of the operations shown in FIG. 21, and may further include an operation not shown in FIG. 21.

In an embodiment of the disclosure, operations S2110 and S2120 may be performed by the electronic device 3000 between operations S1930 and S1940 of FIG. 19. However, the time at which operations S2110 and S2120 are performed is not limited thereto.

In operation S2110, the electronic device 3000 may determine whether to activate the selective adder of a multiplication logic based on identified datatypes and precisions. The electronic device 3000 may determine whether to activate the selective adder mapped to the identified datatypes and precisions. The electronic device 3000 may activate or deactivate the selective adder according to an identification result. For example, the electronic device 3000 may activate the selective adder when the identified datatypes and precisions are bfloat16. For example, the electronic device 3000 may deactivate the selective adder when the identified datatypes and precisions are FP8.

In operation S2120, the electronic device 3000 may determine to activate the selective adder and activate the selective adder that sums outputs of sub-multiplication logics. In an embodiment of the disclosure, the activated selective adder may sum all the outputs of the sub-multiplication logics.

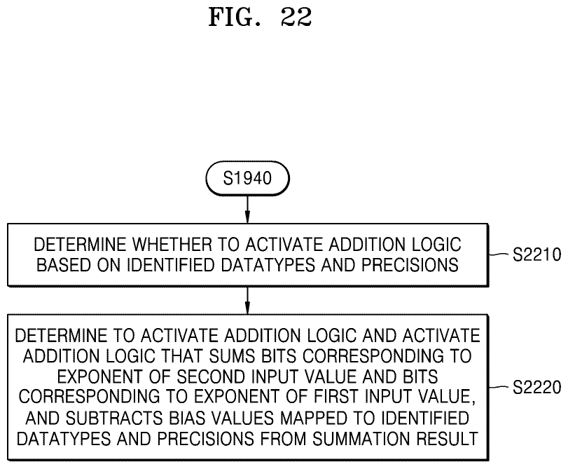

FIG. 22 is a flowchart for explaining the operation of addition logic according to an embodiment of the disclosure. Redundant descriptions given with reference to FIGS. 1 to 21 are omitted.

In an embodiment of the disclosure, operations S2210 and S2220 may be performed by at least one of the electronic device 3000, the multiplier 3110, the hardware accelerator 3100, and the processor 3200 of FIG. 18. However, the disclosure is not limited thereto, and operations S2210 and S2220 may be performed by any electronic device. An operating method of the addition logic or a controlling method of the addition logic according to an embodiment of the disclosure is not limited to that shown in FIG. 22, may omit at least one of the operations shown in FIG. 22, and may further include an operation not shown in FIG. 22.

In an embodiment of the disclosure, operations S2210 and S2220 may be performed by the electronic device 3000 after operation S1940 of FIG. 19. However, the time at which operations S2210 and S2220 are performed is not limited thereto.

In operation S2210, the electronic device 3000 may determine whether to activate the addition logic based on identified datatypes and precisions. In an embodiment of the disclosure, the electronic device 3000 may determine whether to activate at least one sub-addition logic of the addition logic.

In operation S2220, the electronic device 3000 may determine to activate the addition logic and activate the addition logic that sums bits corresponding to an exponent of a second input value and bits corresponding to an exponent of a first input value, and subtracts bias values mapped to the identified datatypes and precisions from a summation result. The at least one sub-addition logic of the activated addition logic may perform addition between exponents by using two adders. One adder may sum the bits corresponding to the exponent of the first input value and the bits corresponding to the exponent of the second input value. Another adder may subtract the bias values mapped to the identified datatypes and precisions from a summation result.

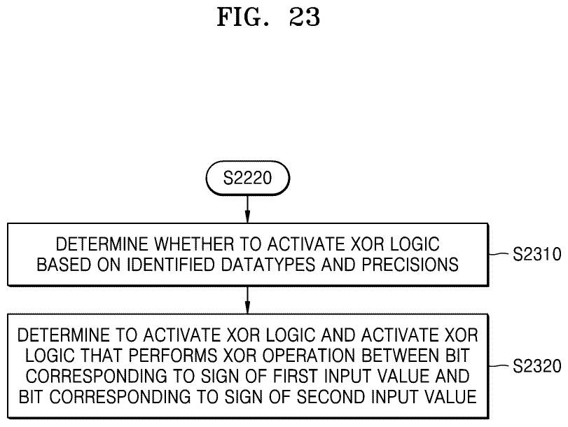

FIG. 23 is a flowchart for explaining the operation of XOR logic according to an embodiment of the disclosure. Redundant descriptions given with reference to FIGS. 1 to 22 are omitted.

In an embodiment of the disclosure, operations S2310 and S2320 may be performed by at least one of the electronic device 3000, the multiplier 3110, the hardware accelerator 3100, and the processor 3200 of FIG. 18. However, the disclosure is not limited thereto, and operations S2310 and S2320 may be performed by any electronic device. An operating method of the XOR logic or a controlling method of the XOR logic according to an embodiment of the disclosure is not limited to that shown in FIG. 23, may omit at least one of the operations shown in FIG. 23, and may further include an operation not shown in FIG. 23.

In an embodiment of the disclosure, operations S2310 and S2320 may be performed by the electronic device 3000 after operation S2220 of FIG. 22. However, the time at which operations S2310 and S2320 are performed is not limited thereto.

In operation S2310, the electronic device 3000 may determine whether to activate the XOR logic based on identified datatypes and precisions. In an embodiment of the disclosure, the electronic device 3000 may determine whether to activate at least one sub-XOR logic of the XOR logic.

In operation S2320, the electronic device 3000 may determine to perform an XOR operation between a bit corresponding to a sign of a first input value and a bit corresponding to a sign of a second input value based on an activation of the XOR logic.

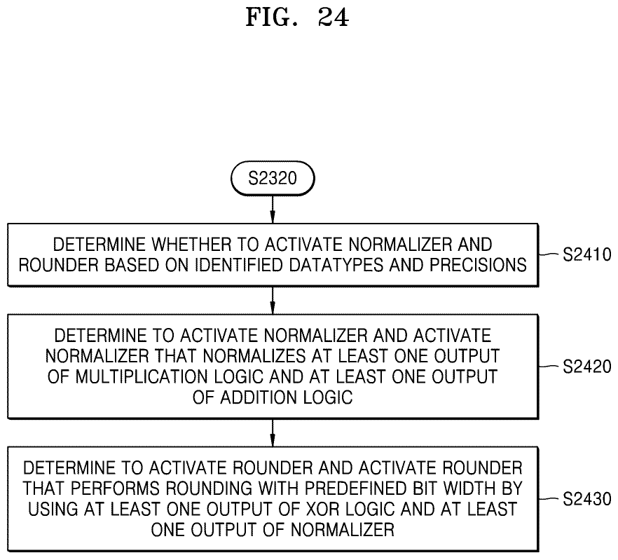

FIG. 24 is a flowchart for explaining the operations of a normalizer and a rounder according to an embodiment of the disclosure. Redundant descriptions given with reference to FIGS. 1 to 23 are omitted.

In an embodiment of the disclosure, operations S2410 to S2430 may be performed by at least one of the electronic device 3000, the multiplier 3110, the hardware accelerator 3100, and the processor 3200 of FIG. 18. However, the disclosure is not limited thereto, and operations S2410 to S2430 may be performed by any electronic device. An operating method of the normalizer and the rounder or a controlling method of the normalizer and the rounder according to an embodiment of the disclosure is not limited to that shown in FIG. 24, may omit at least one of the operations shown in FIG. 24, and may further include an operation not shown in FIG. 24.

In an embodiment of the disclosure, operations S2410 to S2430 may be performed by the electronic device 3000 after operation S2320 of FIG. 23. However, the time at which operations S2410 to S2430 are performed is not limited thereto.

In operation S2410, the electronic device 3000 may determine whether to activate the normalizer and the rounder based on identified datatypes and precisions. In an embodiment of the disclosure, the normalizer may include at least one sub-normalizer. The rounder may include at least one sub-rounder. The number of activated sub-normalizers may be equal to the number of activated sub-rounders.

In operation S2420, the electronic device 3000 may determine to activate the normalizer and activate the normalizer that normalizes at least one output of a multiplication logic and at least one output of an addition logic. In an embodiment of the disclosure, the number of sub-normalizers activated may vary depending on the identified datatypes and precisions.

In operation S2430, the electronic device 3000 may determine to activate the rounder and activate the rounder that performs rounding with a predefined bit width by using at least one output of the XOR logic and at least one output of the normalizer. In an embodiment of the disclosure, the number of activated sub-rounders may vary depending on the identified datatypes and precisions.

According to an embodiment of the disclosure, operations on various precisions and datatypes may be supported while maintaining the accuracy of training or inference of the DNN model.

According to an embodiment of the disclosure, an area-efficient multiplier that supports various precisions and datatypes may be provided. One multiplier may perform multiplication operations not only on floating-point types but also on integer types, and thus, a large number of multipliers may be integrated per unit area. In other words, there is no need to have different multipliers with respect to different precisions and datatypes.

According to an embodiment of the disclosure, a flexible and general-purpose MAC array with high hardware resource utilization with respect to various operations of the DNN model may be provided. The MAC array according to an embodiment of the disclosure is designed to have high resource utilization for both accumulated and non-accumulated operations, and one hardware accelerator is designed to process a plurality of DNN models in parallel.

For example, an application that provides augmented reality or virtual reality service needs to simultaneously perform tasks such as object detection and depth estimation, and thus, to provide the service of the application, the hardware accelerator may process the plurality of DNN models corresponding to the tasks in parallel.

In an embodiment of the disclosure, an electronic device may be provided. The electronic device may include a multiplier including a multiplication logic. The electronic device may include a memory comprising at least one instruction. The electronic device may include at least one processor configured to execute the at least one instruction. The at least one processor may obtain a first input value and a second input value. The at least one processor may identify datatypes and precisions of the first input value and the second input value. The at least one processor may, based on the identified datatypes and precisions, distribute bits of the first input value and bits of the second input value to sub-multiplication logics of the multiplication logic. The at least one processor may obtain at least one output of the multiplication logic based on outputs of the sub-multiplication logics.

In an embodiment of the disclosure, the at least one processor may, based on the identified datatypes and precisions, determine whether to activate at least one shifting logic of the multiplication logic. The at least one processor may determine to activate the at least one shifting logic and activate the at least one shifting logic configured to shift at least one of the outputs of the sub-multiplication logics.

In an embodiment of the disclosure, the at least one processor may, based on the identified datatypes and precisions, determine whether to activate a selective adder of the multiplication logic. The at least one processor may determine to activate the selective adder and activate the selective adder configured to sum outputs of the sub-multiplication logics. The at least one processor may determine to deactivate the selective adder and deactivate the selective adder configured to sum the outputs of the sub-multiplication logics.

In an embodiment of the disclosure, when the identified datatypes are floating-point types, the bits of the first input value distributed to the sub-multiplication logics may be bits corresponding to a mantissa of the first input value.

In an embodiment of the disclosure, the bits of the second input value distributed to the sub-multiplication logics may be bits corresponding to a mantissa of the second input value.

In an embodiment of the disclosure, the multiplier may include an addition logic.

In an embodiment of the disclosure, the at least one processor may, based on the identified datatypes and precisions, determine whether to activate the addition logic. The at least one processor may determine to activate the addition logic and activate the addition logic configured to sum bits corresponding to an exponent of the second input value to bits corresponding to an exponent of the first input value and subtract bias values mapped to the identified datatypes and precisions from a summation result.

In an embodiment of the disclosure, the multiplier may include an XOR logic.

In an embodiment of the disclosure, the at least one processor may, based on the identified datatypes and precisions, determine whether to activate the XOR logic. The at least one processor may determine to activate the XOR logic and activate the XOR logic configured to perform an XOR operation between a bit corresponding to a sign of the first input value and a bit corresponding to a sign of the second input value.

In an embodiment of the disclosure, the XOR logic may include at least one sub-XOR logic.

In an embodiment of the disclosure, the at least one sub-XOR logic may be arranged in the same number as a maximum number of at least one output of the multiplication logic.

In an embodiment of the disclosure, the multiplier may include a normalizer.

In an embodiment of the disclosure, the multiplier may include a rounder.

According to an embodiment of the disclosure, the at least one processor may, based on the identified datatypes and precisions, determine whether to activate the normalizer and the rounder. The at least one processor may determine to activate the normalizer and activate the normalizer configured to normalize at least one output of the multiplication logic and at least one output of the addition logic. The at least one processor may determine to activate the rounder and activate the rounder configured to perform rounding with a predefined bit width by using at least one output of the XOR logic and at least one output of the normalizer.

In an embodiment of the disclosure, the at least one processor may, based on the identified datatypes being integer types, determine at least one output of the multiplication logic to be an output of the multiplier. The at least one processor may, based on the identified datatypes being floating-point types, determine the at least one output of the normalizer as an output of the multiplier.

In an embodiment of the disclosure, an operating method of a multiplier may be provided. The method may include obtaining a first input value and a second input value. The method may include identifying datatypes and precisions of the first input value and the second input value. The method may include, based on the identified datatypes and precisions, distributing bits of the first input value and bits of the second input value to sub-multiplication logics of a multiplication logic included in the multiplier. The method may include obtaining at least one output of the multiplication logic based on outputs of the sub-multiplication logics.

In an embodiment of the disclosure, a multiplier may be provided. The multiplier may include a multiplication logic configured to, based on datatypes of a first input value and a second input value being integer types, perform a multiplication between the first input value and the second input value, and based on the datatypes being floating-point types, perform a multiplication between a mantissa of the first input value and a mantissa of the second input value. The multiplier may include an addition logic configured to, based on the datatypes being floating-point types, sum an exponent of the first input value and an exponent of the second input value, and subtract bias values mapped to bit widths of the exponent of the first input value and the exponent of the second input value from a summation result. The multiplier may include an XOR logic configured to, based on the datatypes being floating-point types, perform an XOR operation between a sign of the first input value and a sign of the second input value. The multiplier may include a normalizer configured to, based on the datatypes being floating-point types, perform normalization an output of the multiplication logic and an output of the addition logic. The multiplier may include a rounder configured to, based on the datatypes being floating-point types, perform rounding with a predefined bit width by using an output of the normalizer and an output of the XOR logic. The multiplier may include a multiplexer configured to, based on the datatypes being integer types, output the output of the multiplication logic, and based on the datatypes being floating-point types, output an output of the rounder.

In an embodiment of the disclosure, a hardware accelerator may be provided. The hardware accelerator may include a MAC array. The MAC array may include a plurality of arrays. The MAC array may include a global multiplexer logic connecting or disconnecting at least two of the plurality of arrays based on a first control signal. Each of the plurality of arrays may include a plurality of sub-arrays including a plurality of first sub-arrays and a second sub-array. Each of the plurality of arrays may include a local multiplexer logic connecting or disconnecting the plurality of sub-arrays based on a second control signal.

In an embodiment of the disclosure, the MAC array may perform a 128×128 matrix operation. Each of the plurality of arrays may may perform a 64×64 matrix operation.

In an embodiment of the disclosure, MAC operators may be arranged in each of the plurality of first sub-arrays in the form of 9×64. MAC operators may be arranged in the second sub-array in the form of 1×64.

In an embodiment of the disclosure, the number of plurality of arrays may be 4. The number of plurality of first sub-arrays may be 7.

In an embodiment of the disclosure, each of the MAC operators may include a multiplier that performs multiplication between an input value and a weight value. Each of the MAC operators may include an adder summing a partial sum value and an output of the multiplier. Each of the MAC operators may include a precision converter that converts precision of the output of the multiplier. Each of the MAC operators may include an adder tree summing the partial sum value and an output of the precision converter. Each of the MAC operators may include a first multiplexer that outputs an output of the adder or an output of the adder tree based on a third control signal.

In an embodiment of the disclosure, based on the first control signal indicating a first operation mode of the MAC array, the global multiplexer logic may disconnect the plurality of arrays from each other.

In an embodiment of the disclosure, based on the first control signal indicating a second operation mode of the MAC array, the global multiplexer logic may connect at least two of the plurality of arrays to each other.

In an embodiment of the disclosure, the plurality of arrays may be grouped into at least one array group by the global multiplexer logic. Each of the at least one array group may perform an operation on different single tenants.

In an embodiment of the disclosure, based on the second control signal indicating a first operation mode of the plurality of arrays, the local multiplexer logic may disconnect the plurality of sub-arrays from each other.

In an embodiment of the disclosure, based on the second control signal indicating a second operation mode of the plurality of arrays, the local multiplexer logic may connect the plurality of sub-arrays to each other.

In an embodiment of the disclosure, the plurality of sub-arrays may generate a partial sum tensor by performing a convolution operation between a first tensor and a second tensor. Based on the second control signal indicating a first operation mode of the plurality of arrays, the plurality of arrays may accumulate a partial sum tensor output by each of the plurality of sub-arrays. Based on the second control signal indicating a second operation mode of the plurality of arrays, the plurality of arrays may not accumulate the partial sum tensor output by each of the plurality of sub-arrays.

In an embodiment of the disclosure, a MAC array may be provided. The MAC array may include four arrays, each including seven first sub-arrays, one second sub-array, and local multiplexer logic. The MAC array may include global multiplexer logic disposed between the arrays. Each of the first sub-arrays may include a plurality of MAC operators arranged in the form of 9×64. The second sub-array may include a plurality of MAC operators arranged in the form of 1×64. The local multiplexer logic may be disposed between the first sub-arrays and the second sub-array.

In an embodiment of the disclosure, the global multiplexer logic may include a plurality of first multiplexers connected between the plurality of MAC operators disposed in a last row, a last column, a first row, or a first column of the arrays.

In an embodiment of the disclosure, each of the plurality of first multiplexers may transfer an output (e.g., a partial sum or forwarded data) of one of the arrays to another array based on the first control signal corresponding to a first logic value. Each of the plurality of first multiplexers may not transfer the output (e.g., a partial sum or forwarded data) of one of the arrays to another array, based on the first control signal corresponding to a second logic value.

In an embodiment of the disclosure, the local multiplexer logic may include a plurality of second multiplexers connected to the plurality of MAC operators arranged in a last row or a last column of the first sub-arrays.

In an embodiment of the disclosure, each of the plurality of second multiplexers may transfer an output of one of the first sub-arrays to another first sub-array or the second sub-array based on the second control signal corresponding to the first logical value. Each of the plurality of second multiplexers may not transfer the output of one of the first sub-arrays to another first sub-array or the second sub-array based on the second control signal corresponding to the second logical value.

In an embodiment of the disclosure, when the second control signal corresponds to the first logic value, each of the arrays may perform a 64×64 matrix operation.

In an embodiment of the disclosure, values of the weight tensor corresponding to an input channel may be respectively prefetched to the arrays in a column direction.

Values of the weight tensor corresponding to an output channel may be respectively prefetched to the arrays in a row direction.

In an embodiment of the disclosure, when the second control signal corresponds to the second logic value, values of a weight filter of the weight tensor may be respectively prefetched to the first sub-arrays in the column direction. When the second control signal corresponds to the second logic value, the values of the weight tensor corresponding to the output channel may be respectively prefetched to the arrays in the row direction.

In an embodiment of the disclosure, when the second control signal corresponds to the second logic value, the MAC operators of the second sub-array may be grouped into seven groups of nine each.

In an embodiment of the disclosure, the values of the weight tensor may be respectively prefetched the seven groups.

A method according to an embodiment may be implemented in the form of program instructions executable by various computer means and be recorded on a computer-readable recording medium. The computer-readable recording medium may include program instructions, data files, data structures, or the like alone or in combination. The program instructions recorded on the computer-readable recording medium may be program instructions specially designed and configured for the disclosure or program instructions known and available to those of ordinary skill in the field of computer software. Examples of the computer-readable recording medium may include magnetic media such as a hard disk, a floppy disk, and magnetic tape, optical recording media such as compact disc read-only memory (CD-ROM) and a digital versatile disk (DVD), magneto-optical media such as a floptical disk, and hardware devices such as ROM, RAM, and flash memory, which are specially configured to store and execute program instructions. Examples of the program instructions may include machine language code produced by a compiler and high-level language code executable by a computer by using an interpreter or etc.

Some embodiments of the disclosure may be implemented in the form of a recording medium including instructions executable by a computer, such as program modules executed by a computer. The computer-readable recording medium may be any available medium accessible by a computer and includes volatile and non-volatile media and separable and non-separable media. In addition, the computer-readable recording medium may include a computer storage medium and a communication medium. The computer-readable recording medium includes volatile and non-volatile media and separable and non-separable media, which are implemented by any method or technique for storing information, such as computer-readable instructions, data structures, program modules, or other data. The communication medium typically includes computer-readable instructions, data structures, program modules, other data in modulated data signals such as carrier waves, or other transfer mechanisms, and includes any information transfer medium. In addition, some embodiments of the disclosure may be implemented in the form of a computer program or computer program product including instructions executable by a computer, such as a computer program executed by a computer

In an embodiment of the disclosure, a machine-readable storage medium may be provided in the form of a non-transitory storage medium. Here, the term “non-transitory storage medium” only means that the storage medium is tangible and does not include signals (for example, electromagnetic waves), whether data is semi permanently or temporarily stored in the storage medium or not. For example, the “non-transitory storage medium” may include a buffer in which data is temporarily stored.

According to an embodiment of the disclosure, a method according to various embodiments may be provided while included in a computer program product. The computer program product may be traded as merchandise between a seller and a purchaser. The computer program product may be distributed in the form of a machine-readable storage medium (for example, CD-ROM) or may be distributed (for example, downloaded or uploaded) online through an application store or directly between two user devices (for example, smartphones). In the case of online distribution, at least a portion of the computer program product (for example, a downloadable app) may be at least temporarily stored in a machine-readable storage medium, such as a memory of a server of a manufacturer, a server of an application store, or a relay server, or may be temporarily generated.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An electronic device comprising:
a multiplier comprising a multiplication logic;
a memory storing at least one instruction; and
at least one processor configured to execute the at least one instruction to:
obtain a first input value and a second input value,
identify datatypes and precisions of the first input value and the second input value,
based on the identified datatypes and precisions, distribute bits of the first input value and bits of the second input value to sub-multiplication logics of the multiplication logic, and
obtain at least one output of the multiplication logic based on outputs of the sub-multiplication logics.

2. The electronic device of claim 1, wherein
the at least one processor is configured to,
based on the identified datatypes and precisions, determine whether to activate at least one shifting logic of the multiplication logic, and
determine to activate the at least one shifting logic and activate the at least one shifting logic configured to shift at least one of the outputs of the sub-multiplication logics.

3. The electronic device of claim 1, wherein the at least one processor is configured to, based on the identified datatypes and precisions, determine whether to activate a selective adder of the multiplication logic.

4. The electronic device of claim 3, wherein
the at least one processor is configured to
determine to activate the selective adder and activate the selective adder configured to sum outputs of the sub-multiplication logics, and
determine to deactivate the selective adder and deactivate the selective adder configured to sum the outputs of the sub-multiplication logics.

5. The electronic device of claim 1, wherein when the identified datatypes are floating-point types, the bits of the first input value distributed to the sub-multiplication logics are bits corresponding to a mantissa of the first input value, and the bits of the second input value distributed to the sub-multiplication logics are bits corresponding to a mantissa of the second input value.

6. The electronic device of claim 1, wherein
the multiplier includes an addition logic, and
the at least one processor is configured to,
based on the identified datatypes and precisions, determine whether to activate the addition logic, and
determine to activate the addition logic and activate the addition logic configured to sum bits corresponding to an exponent of the second input value to bits corresponding to an exponent of the first input value and subtract bias values mapped to the identified datatypes and precisions from a summation result.

7. The electronic device of claim 6, wherein
the multiplier includes an XOR logic, and
the at least one processor is configured to,
based on the identified datatypes and precisions, determine whether to activate the XOR logic, and
determine to activate the XOR logic and activate the XOR logic configured to perform an XOR operation between a bit corresponding to a sign of the first input value and a bit corresponding to a sign of the second input value.

8. The electronic device of claim 7, wherein
the XOR logic includes at least one sub-XOR logic, and
the at least one sub-XOR logic is arranged in a same number as a maximum number of at least one output of the multiplication logic.

9. The electronic device of claim 7, wherein
the multiplier includes a normalizer and a rounder, and
the at least one processor is configured to,
based on the identified datatypes and precisions, determine whether to activate the normalizer and the rounder,
determine to activate the normalizer and activate the normalizer configured to normalize at least one output of the multiplication logic and at least one output of the addition logic, and
determine to activate the rounder and activate the rounder configured to perform rounding with a predefined bit width by using at least one output of the XOR logic and at least one output of the normalizer.

10. The electronic device of claim 9, wherein
the at least one processor is configured to,
based on the identified datatypes being integer types, determine at least one output of the multiplication logic to be an output of the multiplier, and
based on the identified datatypes being floating-point types, determine the at least one output of the normalizer as an output of the multiplier.

11. An operating method of a multiplier, the operating method comprising:
obtaining a first input value and a second input value,
identifying datatypes and precisions of the first input value and the second input value,
based on the identified datatypes and precisions, distributing bits of the first input value and bits of the second input value to sub-multiplication logics of a multiplication logic included in the multiplier, and
obtaining at least one output of the multiplication logic based on outputs of the sub-multiplication logics.

12. The operating method of claim 11, further comprising:
based on the identified datatypes and precisions, determining whether to activate at least one shifting logic of the multiplication logic, and
determining to activate the at least one shifting logic and activating the at least one shifting logic configured to shift at least one of the outputs of the sub-multiplication logics.

13. The operating method of claim 11, further comprising: based on the identified datatypes and precisions, determining whether to activate a selective adder of the multiplication logic.

14. The operating method of claim 13, wherein
the determining of whether to activate the selective adder of the multiplication logic includes
determining to activate the selective adder and activating the selective adder configured to sum outputs of the sub-multiplication logics; and
determining to deactivate the selective adder and deactivating the selective adder configured to sum the outputs of the sub-multiplication logics.

15. The operating method of claim 11, wherein when the identified datatypes are floating-point types, the bits of the first input value distributed to the sub-multiplication logics are bits corresponding to a mantissa of the first input value, and the bits of the second input value distributed to the sub-multiplication logics are bits corresponding to a mantissa of the second input value.

16. The operating method of claim 11, wherein
the multiplier includes an addition logic, and
the operating method further comprising:
based on the identified datatypes and precisions, determining whether to activate the addition logic; and
determining to activate the addition logic and activating the addition logic configured to sum bits corresponding to an exponent of the second input value to bits corresponding to an exponent of the first input value and subtract bias values mapped to the identified datatypes and precisions from a summation result.

17. The operating method of claim 16, wherein
the multiplier includes an XOR logic,
the operating method further comprising:
based on the identified datatypes and precisions, determining whether to activate the XOR logic, and
determining to activate the XOR logic and activating the XOR logic configured to perform an XOR operation between a bit corresponding to a sign of the first input value and a bit corresponding to a sign of the second input value.

18. The operating method of claim 17, wherein
the XOR logic includes at least one sub-XOR logic, and
the at least one sub-XOR logic is arranged in a same number as a maximum number of at least one output of the multiplication logic.

19. The operating method of claim 17, wherein
the multiplier includes a normalizer and a rounder,
the operating method further comprising:
based on the identified datatypes and precisions, determining whether to activate the normalizer and the rounder,
determining to activate the normalizer and activating the normalizer configured to normalize at least one output of the multiplication logic and at least one output of the addition logic, and
determining to activate the rounder and activating the rounder configured to perform rounding with a predefined bit width by using at least one output of the XOR logic and at least one output of the normalizer.

20. A multiplier comprising:
a multiplication logic configured to, based on datatypes of a first input value and a second input value being integer types, perform a multiplication between the first input value and the second input value, and based on the datatypes being floating-point types, perform a multiplication between a mantissa of the first input value and a mantissa of the second input value;
an addition logic configured to, based on the datatypes being floating-point types, sum an exponent of the first input value and an exponent of the second input value, and subtract bias values mapped to bit widths of the exponent of the first input value and the exponent of the second input value from a summation result;
an XOR logic configured to, based on the datatypes being floating-point types, perform an XOR operation between a sign of the first input value and a sign of the second input value;
a normalizer configured to, based on the datatypes being floating-point types, perform normalization an output of the multiplication logic and an output of the addition logic;
a rounder configured to, based on the datatypes being floating-point types, perform rounding with a predefined bit width by using an output of the normalizer and an output of the XOR logic; and
a multiplexer configured to, based on the datatypes being integer types, output the output of the multiplication logic, and based on the datatypes being floating-point types, output an output of the rounder.
